(19) United States
(12) Patent Application Publication
(10) Pub. No.: US 2009/0247420 A1
(43) Pub. Date: Oct. 1, 2009

(54) METHOD FOR ENCODING AND SCREENING COMBINATORIAL LIBRARIES

(76) Inventors: Andrei G. Kutateladze, Centennial, CO (US); Rudresha Kottani, Tucson, AZ (US); Roman Valiulin, Denver, CO (US); Janaki Majjigapu, Menomonee, WI (US)

Correspondence Address: GREENLEE WINNER AND SULLIVAN P C, 4875 PEARL EAST CIRCLE, SUITE 200, BOULDER, CO, 80301, US

(21) Appl. No.: 12/096,928

(22) PCT Filed: Dec. 7, 2006
(86) PCT No.: PCT/US06/61728

§ 371 Date: Sep. 2, 2008

Related U.S. Application Data
(60) Provisional application No. 60/749,442, filed on Dec. 12, 2005.

(51) Int. Cl. C40B 30/04; C40B 40/04

(52) U.S. Cl. 506/9; 506/15

(57) ABSTRACT

A method of screening a library comprising: (i) providing either (a) a library comprising more than one copy of different library members, each copy of a different library member attached to a different releasable tag through a releasable covalent bond; where a plurality of tags uniquely encode each library member; or (b) a library comprising one or more copies of a library member attached to a support, with a plurality of tags uniquely encoding each library member; or (c) a library comprising different library members, each different library member attached to a plurality of tags uniquely encoding the different library member; (ii) providing a target compound with tethered sensitizer in specific binding proximity to the library, allowing specific binding of the target compound with tethered sensitizer to a selected library member; (iii) exciting the tethered sensitizer with excitation photoradiation, whereby the releasable tags attached to the selected library member are released; and (iv) detecting the releasable tags.

### CROSS REFERENCE TO RELATED APPLICATIONS

This application claims priority from U.S. provisional application 60/749,442, filed Dec. 12, 2005, which is incorporated herein to the extent not inconsistent with the disclosure herewith.

### STATEMENT REGARDING FEDERALLY SPONSORED RESEARCH OR-DEVELOPMENT

This invention was made, at least in part, with funding from the National Science Foundation under contract CHE-314344. Accordingly, the U.S. government may have certain rights in this invention.

### BACKGROUND OF THE INVENTION

The detection of interactions between small molecules such as ligands and receptors is important in developing and using analytical assays and screening assays, among other uses. Current methods used to detect and study interactions between small molecules suffer from many disadvantages.

Encoded combinatorial libraries are currently screened and analyzed in the following way. The library is normally immobilized on a polymeric bead with each bead displaying one library member (i.e. “one bead-one compound” approach). The beads are encoded with molecular tags introduced as the synthesis of a library progresses. The library is then screened, most commonly with a biological molecule of interest conjugated to a fluorescent marker. The “winning” beads are mechanically separated based on their fluorescence. Each bead is placed in a small reaction vessel, in which its tags are cleaved off the polymeric support and analyzed, revealing the identity of the encoded combinatorial library member. This technique involves a series of steps to mechanically separate winning beads and analyze the library member. In addition, the beads used must be large enough to be handled mechanically. Smaller carrier particles or libraries composed of individual molecules (unsupported) can not be screened using existing techniques.

A fundamentally different library screening method is needed.

### SUMMARY OF THE INVENTION

Provided is a method for screening tag-encoded combinatorial libraries based on the sensitized release of tags into solution for easy detection. The current invention does not require any mechanical handling of the library components. No matter how small the supporting “beads” are (down to individual molecules), this invention allows for screening of the encoded combinatorial libraries in solution without the need for mechanical separation of the library members.

In general, a tagged library member is prepared via formation of a photolabile covalent bond between a library member (compound) and releasable tag. A sensitizer attached to a target (tethered sensitizer) is brought into specific binding proximity with the tagged library member. A molecular recognition event brings the two moieties, i.e. the sensitizer and the tagged library member, in the immediate vicinity of each other. This ensures that only after such molecular recognition event, the system is “armed” and ready to photocleave when irradiated. External irradiation at the absorption wavelength of the tethered sensitizer causes cleavage of the adduct via expulsion of a radical leaving group (releasable tag).

More specifically, provided is a method for screening a library comprising (i) providing either (a) a library comprising more than one copy of different library members, each copy of a different library member attached to a different releasable tag through a releasable covalent bond; where a plurality of tags uniquely encode each different library member; or (b) a library comprising one or more copies of a library member attached to a support, with a plurality of tags uniquely encoding each library member; or (c) a library comprising different library members, each different library member attached to a plurality of tags uniquely encoding the different library member; (ii) providing a target compound with a tethered sensitizer in specific binding proximity to the library, allowing specific binding of the target compound with tethered sensitizer to the copies of the selected library member; (iii) exciting the tethered sensitizer with excitation photoradiation at the absorption wavelength of the tethered sensitizer, whereby the releasable tags attached to the copies of the selected library member are released; and (iv) detecting the releasable tags. In one embodiment, cleavage of the tag occurs via expulsion of a radical leaving group.

Also provided is a library comprising: a plurality of library members, each different library member attached to a plurality of different releasable tags through releasable covalent bonds. Also provided is a library comprising library members, wherein one or more copies of a library member is attached to a support, with a plurality of tags uniquely encoding each library member. Also provided is a library comprising: one or more library members, each different library member attached to a plurality of tags uniquely encoding the different library member.

Also provided is a kit for conducting an assay for an analyte, which kit comprises, in packaged combination, a composition comprising: a plurality of library members, each library member attached to a plurality of different releasable tags through releasable covalent bonds. In one embodiment, the plurality of library members is provided in solution or suspension without a support. In one embodiment, the plurality of library members is attached to a support. A support can be a molecule.

Also provided is a kit for conducting an assay for an analyte, which kit comprises, in packaged combination; a composition comprising: one or more copies of a library member attached to a support with a plurality of tags uniquely encoding each library member. Also provided is a kit for conducting an assay for an analyte, which kit comprises, in packaged combination; a composition comprising: one or more library members, each different library member attached to a plurality of tags uniquely encoding the different library member.

This invention can be used in many different ways, including the following.

In one embodiment, one molecule of a dendrimer serves as a support for many molecules of one library member and all the tags necessary to encode this library member. A different molecule of a dendrimer serves as a support for many molecules of another library member and all the tags necessary to encode this library member, and so on. The dendrimers are brought into contact with the target compound with tethered sensitizer, and the analysis is performed as described herein. In another embodiment, individual tags are tethered to individual molecules of a library member so that there are several sub-populations of the same library member, each sub-population having different tags attached to the same library member. In another embodiment, a plurality of tags are tethered to one molecule of a library member. The analysis in each case is performed as described herein.

### BRIEF DESCRIPTION OF THE DRAWING

FIG. 1 shows a typical first derivative GC-MS chromatogram of a series of alkyldithiane tags encoding, as an example, a decimal number 207.

FIG. 2 shows the first derivative GC-MS single ion monitoring (SIM) traces. (A) shows the trace encoding biotin in binary 100100001, obtained after the photolytic assay. (B) shows the trace for all nine alkyl dithianes at 1 pmol per injection.

### DETAILED DESCRIPTION OF THE INVENTION

The invention is further described by the following non-limiting description.

Releasable tags are selected from the group consisting of: dithianes, trithianes, dithiazines, tert-alkyls, nitrile, carboxamide and other carbonyl-stabilized radical leaving groups, including carbonyl-dithiane adducts, ester-dithiane diadducts, amino alcohols, diols, arylmethanes and other compounds known in the art to fragment under photoinduced sensitization. The actual moiety tethered to the library member can be either the carbonyl component or dithiane. In the first case it is the dithiane that is released and analyzed in solution. In the second, it is the carbonyl compound which is released and analyzed. In one embodiment, the target compound with tethered sensitizer is a biomolecule. In one embodiment, the target compound with tethered sensitizer contains a member of the group consisting of: carbonyl-, cyano-, nitro-, amino-, and sulfido-groups. Designing of tags can be carried out by one of ordinary skill in the art using the methods and purposes described herein. Some considerations that may be taken into account for designing of tags, depending on the system being studied include: (a) the tags should be amenable for detection at very low concentrations using analytic techniques; (b) the tags should not possess any functional groups that interfere with the interactions being investigated; (c) the tags should not interfere with synthetic steps to the extent that the synthesis cannot be performed; and (d) the tags should be able to separate from the screening environment.

Examples of sensitizers include: benzophenones, xanthones, anthraquinones, dicyanonaphthalene, and dicyanoanthracene groups. The library may be present on a support, although that is not required. The library member may be synthesized on a support and then cleaved from the support, either before contact with the sensitizer or before analysis of the released tags. In one embodiment, the target compound and selected library member are members of a ligand-receptor pair. The detecting step may be performed using any suitable method known in the art, for example, GC-MS.

As used herein, “library member” indicates one of a group of compounds to be screened for binding to the target compound or object. As used herein, “releasable tags” that can be used are those groups that are releasable through photoinduced sensitization mechanism, such as dithiane-carbonyl adducts and bis-dithiane adducts of esters and other compounds as known in the art and described herein. As used herein, “releasable covalent bond” is a covalent bond which can be broken by interaction with an excited sensitizer. As used herein, “specific binding proximity” indicates two groups are placed in proximity with each other so that they will bind, if they are capable of specific binding, as defined herein. As used herein, “target compound with tethered sensitizer” is a target compound that is attached to a sensitizer, either directly or through a linker group. Target compounds include those compounds for which the binding to library members is screened. Target compounds may be first members of a specific binding pair, where one or more library members is the second member of a specific binding pair. Target compounds include biomolecules as defined herein, proteins, peptides, DNA, RNA, lipids, carbohydrates and other target compounds as known to one of ordinary skill in the art. As used herein, “sensitizer” is a molecule which can be excited using radiation to an excited state (forming an excited sensitizer), whereby either excitation energy or an electron can be transferred from (or to) the excited state to (or from) another molecule (for example an adduct comprising a releasable tag). Examples of oxidative electron-transfer sensitizers include benzophenones, xanthones, dicyanonaphthalene, dicyanoanthracene, anthraquinones and other compounds possessing carbonyl-, cyano-, nitro- and other electron withdrawing substituents, as known in the art. Examples of reductive electron-transfer sensitizers include compounds possessing amino-, sulfido- and other electron donating substituents as known in the art. Examples of energy transfer sensitizers include aromatic ketones and hydrocarbons, such as benzophenones, anthraquinones, anthracenes, naphthalenes and other suitable molecules as known in the art.

As used herein, “specific binding pair member” refers to one of two different molecules which specifically binds to the other molecule. One example of the members of the specific binding pair are ligand and receptor. Other examples of the members of the specific binding pair are members of an immunological pair such as an antigen-antibody, hormone-hormone receptor, and other pairs known in the art. “Ligand” refers to any molecule for which a receptor naturally exists or can be prepared. Any member of a specific binding pair can be modified to include groups that allow binding to the sensitizer or releasable tags, or other groups for any convenient purpose, as known in the art. “Specific binding” refers to the specific recognition of one of two different molecules for the other compared to less recognition of other molecules.

As used herein, “excitation photoradiation” is light having the appropriate energy (wavelength) to excite a sensitizer and to enable it to initiate energy or electron transfer resulting in fragmentation of a releasable covalent bond, as known in the art. The appropriate wavelength of excitation photoradiation is determined by measuring the absorbance spectrum of the sensitizer or target compound with tethered sensitizer, as known in the art. Examples of excitation photoradiation include wavelengths in the ultraviolet spectrum, visible and infrared spectrum (between about 180 nm and 1.5 μm, for example) and all individual values and ranges therein, including UV-A (between about 320 and about 400 nm); UV-B (between about 280 and about 320 nm); and UV-C (between about 200 and about 280 nm). Other useful ranges include the radiation in the visible, near-IR and IR ranges (about 500 nm to about 1.5 μm).

The photoinduced fragmentation reaction can occur as a result of a single photon absorption or two photon absorption. The actual wavelength of irradiation depends on difference of the UV/Vis (or near-IR for the two photon cases) absorption maximum of the sensitizer and the adduct (library member bound to releasable tag). For example, substituted benzophenones, that absorb light around 350-370 nm can be selectively excited in the presence of the adducts, because the adducts have absorption maxima below 300 nm.

In one embodiment, the photoinduced fragmentation releases carbonyl compounds, which have strong IR absorption in the vicinity of 1700 cm⁻¹. This can also be used in analytical applications.

Some highly conjugated aromatic compounds possess high two photon absorption cross sections. If such compounds are used for sensitization of fragmentation in dithiane-carbonyl adducts, these applications can be implemented with a high spatial control using high intensity lasers (typically femtosecond Ti-Sapphire lasers).

As used herein, “fluorescence” includes phosphorescence. As used herein, “support” or “surface” or “bead” indicates a material to which a molecule used in the invention can be configured to attach. “Support” or “surface” does not necessarily indicate a substantially flat surface. A support can be a molecule, dendrimer or other suitable substance. The support or surface can have any of a number of shapes, such as strip; rod; particle, including bead; and other suitable shapes. Examples of surfaces include conductive, semi-conductive, and non-conductive, including metal, silicon, ITO, glass and quartz. Conductive surfaces include metal-containing surfaces, or non-metal surfaces with at least a partially electrically conductive layer or portion thereof attached thereto. Examples of electrically conductive materials include metals, such as copper, silver, gold, platinum, palladium, and aluminum; metal oxides, such as platinum oxide, palladium oxide, aluminum oxide, magnesium oxide, titanium oxide, tin oxide, indium tin oxide, molybdenum oxide, tungsten oxide, and ruthenium oxide; and electrically conductive polymeric materials, and mixtures thereof. For certain applications, an electrically conductive material can be deposited on or otherwise applied to a substrate to form a conductive surface. For example, an electrically conductive material can be deposited on a glass substrate or a silicon wafer or a plastic substrate to form a conductive surface. The substrate can be flexible. In other applications, the substrate is itself conductive such as a metal substrate. In some instances, a conductive layer can have a substantially uniform thickness and a substantially flat outer surface. In other instances, a conductive layer can have a variable thickness and a curved, stepped, or jagged outer surface. As used herein, “outer” means the side of the layer that is away from the substrate.

As used herein, a molecule having a “carbonyl group” contains the following structure:

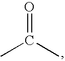

As used herein, a “dendrimer” is a structure formed from regular, highly branched monomers leading to a monodisperse, tree-like or generational structure. Dendrimers are built one monomer layer, or “generation,” at a time. A dendrimer comprises a multifunctional core molecule with a dendritic wedge attached to each functional site. The core molecule is referred to as “generation 0.” Each successive repeat unit along all branches forms the next generation, “generation 1,” “generation 2,” and so on until the terminating generation. An example of a dendrimer is the commercially available PAMAM dendrimer (Aldrich Chemical Co. As used herein, a “particle” is a discrete support that can be coated or partially coated with a variety of materials, such as groups having functional groups allowing attachment of molecules. Examples of particles include commercially available particles such as TentaGel beads (Fluka Chemical Co.). As used herein, “liposome” is a fluid-filled structure whose walls are made of layers of phosopholipids. As used herein, “layer” does not necessarily indicate a complete monolayer is formed. There may be one or more gaps or defects in the layer, and there may be more than one monolayer with or without gaps or defects.

As used herein, “molecule” refers to a collection of chemically bound atoms with a characteristic composition. As used herein, a molecule can be neutral or can be electrically charged. The term molecule includes biomolecules, which are molecules that are produced by an organism or are important to a living organism, including, but not limited to, proteins, peptides, lipids, DNA molecules, RNA molecules, oligonucleotides, carbohydrates, polysaccharides, glycoproteins, lipoproteins, sugars and derivatives, variants and complexes and labeled analogs of these. As used herein, “substantially” means more of the given structures have the listed property than do not have the listed property. As used herein, “about” is intended to indicate the value given is not necessarily exact, either as a result of the inherent uncertainty in measurement, or because the values surrounding the value given function in the same way as the value given. As used herein, “attach” refers to a coupling or joining of two or more chemical or physical elements. Examples of attachment include chemical bonds such as chemisorptive bonds, covalent bonds, ionic bonds, van der Waals bonds, and hydrogen bonds. Various organic solvents and aqueous solutions, and mixtures thereof can be used in the reactions described herein, as known in the art. Additives such as buffers can be used as long as the additives do not prevent the desired reactions from occurring.

It is noted that library members and sensitized target molecules can be made with any desired group(s) using the disclosure herein and using methods of organic synthesis known in the art. These desired groups are apparent to one of ordinary skill in the art in view of the disclosure herein and these compounds can be made using art known methods without undue experimentation. The formation of the releasable covalent bond between the library members and releasable tags can be before, after, or during attachment of any portion thereof to a support or other structure, if used. Unless otherwise specified, all groups described herein, including library members and target compound with tethered sensitizers can be optionally substituted with various groups, such as groups that allow attachment to another group, groups that allow attachment to a surface, allow alteration of the optical properties of the group, groups that are present in commercially available analogues of groups or are as a result of synthesis methods used, as long as the substitution does not interfere with the desired use. For example, the library member may be attached to the releasable tags through “tether” groups, which may provide a variety of useful purposes, for example, providing the desired structural length and/or structural flexibility between the library members and releasable tags. Examples of tether groups are provided herein, and include alkyl chains of suitable length (for example 1 to 30 carbon atoms) optionally substituted with one or more groups such as heteroatoms, such as O or N; carboxylate groups and halogens. Ring structures can be optionally substituted with one or more halogens, such as fluorine or chlorine. Ring structures can also be substituted with one or more heteroatoms in the ring, for example. Other substituents can be added to various groups including ring structures, such as alkyl groups, alkylene groups, alkenyl groups, alkenylene groups, alkynyl groups, alkynylene groups, aryl groups, arylene groups, iminyl groups, iminylene groups, hydride groups, halo groups, hydroxy groups, alkoxy groups, carboxy groups, thio groups, alkylthio groups, disulfide groups, cyano groups, nitro groups, amino groups, alkylamino groups, dialkylamino groups, silyl groups, and siloxy groups. Any combination of suitable substituents may be used, and all combinations of substituents are intended to be included to the extent that they were specifically listed.

Any component of the system may be deuterated or contain other isotopic substitutions. Preparation and characterization of isotopically substituted compounds is well known in the art. Isotopic substitutions allows a way to increase the variety of tags used, for example, and allows alternative detection methods to be used.

The number of dithiane-based tags can be easily doubled, tripled etc. by deuterium isotopic substitution in the dithiane ring. The following illustrates an example of this technique. Since the fragmentation of the C2-alkyl bond is the most efficient fragmentation pattern in dithianes, the 2-dithianyl cation radical (119) is the highest intensity ion. Harvesting all of it enhances the sensitivity (and the signal to noise ratio) of the mass-selective detection. Starting from bis-deuterated diethylmalonate, CD₂(COOEt)₂, 2-dideutero-1,3-propanedithiol has been synthesized and reacted with a large set of aldehydes to furnish 4,4-dideutero-2-alkyl-1,3-dithianes. The GCMS single ion monitoring for 119 and 121 allows differentiating between the two tags, without the necessity to actually resolve the peaks—the traces for two ion currents are simply printed separately. Synthesis of the dideuterated malonate involved H-D exchange with D₂O. 1,1,3,3-tetradeuterated propanediol is synthesized by reducing diethylmalonate with LiAlD₄, while hexadeuterated propanediol—by reducing CD₂(COOEt)₂ with LiAlD₄. The increment of two mass units is confidently differentiated by a HP GCMS instrument. Each set of alkyl dithianes can be represented by a non-, di-, tetra- and hexa-deuterated series, quadrupling the number of tags. Potentially, deuteration in increments of 1 amu can be achieved to produce seven sets of dithiane tags.

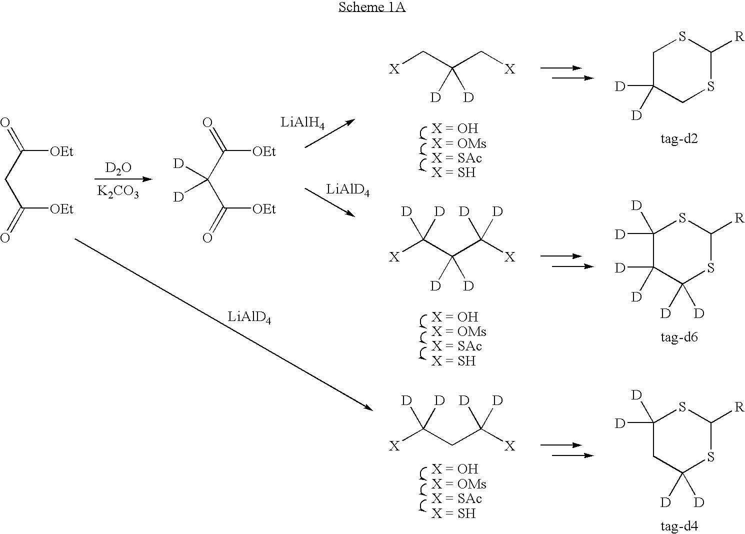

Scheme 1A shows an exemplary scheme showing deuteration.

Schemes 1-3 describe one general approach used in the invention.

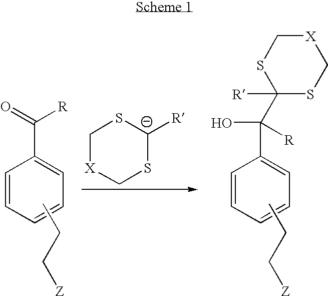

Scheme 1 shows the synthesis of tethered tag precursors based on aldehyde or ketone monoadducts. In certain embodiments, R is independently selected from the group consisting of: H, straight chain and branched unsubstituted or substituted alkyl having from 1 to 30 carbon atoms, —Cₙ—Y—Cₘ— wherein Y is S or O, and n and m are independently integers from 0 to 25, and OH or other group (such as those shown in Scheme 11 or described herein or known to one of ordinary skill in the art), chosen to allow for photoinduced externally sensitized fragmentation, producing the free carbonyl compound that is not capable of further sensitization (i.e. amplification); R′ can be an alkyl or tethered nucleophilic or electrophilic handle for mass-discrimination or other analytical technique-based discrimination of tags, as known in the art. Z can be a carboxy-, amino- or other groups to tether the assembled tag to combinatorial beads or individual molecules. X can be CR₂″ or S, NR′″ or any other substitution that does not interfere with the photoinduced fragmentation chemistry as described herein. Specific nonlimiting examples of R, R′, R″ and R′″ are independently, hydrogen; substituted or unsubstituted alkyl, where the substitutions are heteroatoms, halogens or any other suitable substitution as known in the art; or any group tethered through an alkyl chain. Some embodiments include hydrogen and primary alkyl. In one embodiment, alkyl groups have from 1-30 carbons. In one embodiment, alkyl groups have from 1 to 6 carbons. In one embodiment, alkyl groups have from 1 to 25 carbons. Alkyl groups are straight chain or branched.

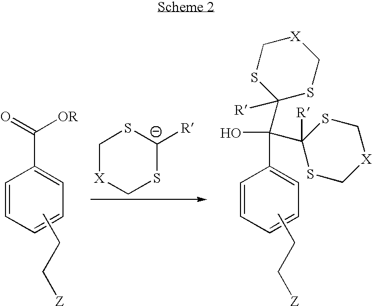

Scheme 2 shows the synthesis of tethered tag precursors based on bis-adducts of esters. R can be any group, preferably methyl, to facilitate the nucleophilic addition. The only requirement is that any substitution in the bis-adducts does not prevent the photoinduced externally sensitized fragmentation, producing the free carbonyl compound that is not capable of further sensitization (i.e. amplification). The other variables are as defined above.

Scheme 3 shows an example of photoinduced fragmentation releasing a dithianeltrithiane based tag as the result of sensitization by an electron transfer brought into the vicinity of the adduct. In the example shown in Scheme 3, a monoadduct is shown. However, bis-adducts or other adducts may be used.

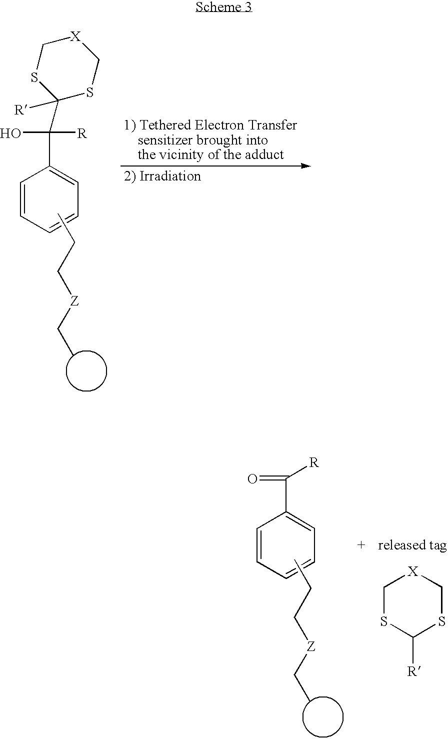

### Example 1

Scheme 4 shows one example of the screening procedure used.

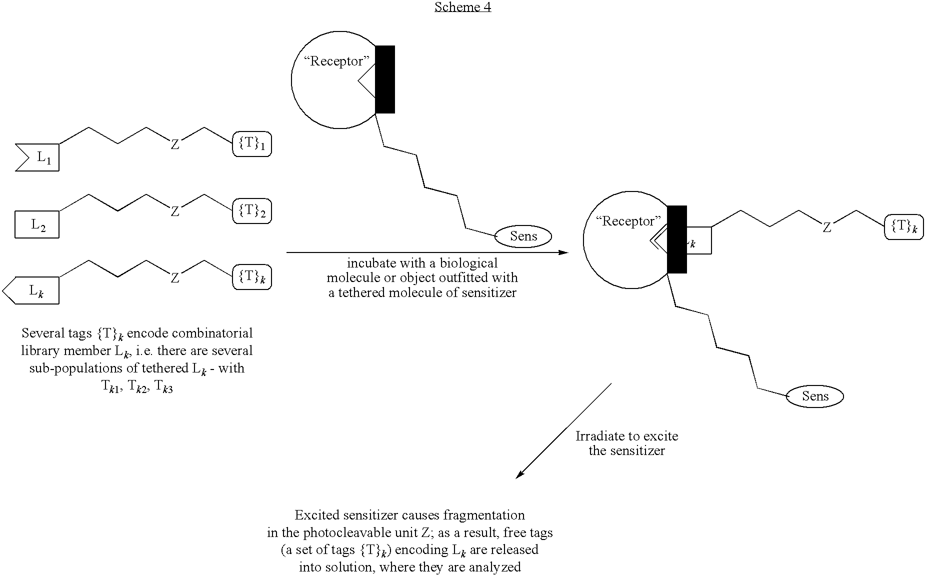

In this example, ligand-receptor binding is probed. A combinatorial library is created by attaching different releasable tags to a plurality of different library members (ligands, for example). The releasable tags can only be cleaved from the library members in the presence of an external sensitizer. It is preferred that the library be present as a solution or suspension. The library can be created on solid support beads or other supports using methods known in the art, although this is not required, and is not a currently preferred embodiment. As known in the art, suitable linking groups can be used between the ligands and tags, as desired for ease of synthesis, or for other reasons such as to provide the desired spacing of the ligand and tag. Some suitable linking groups are shown in the examples herein, and others are easily known by one of ordinary skill in the art using the disclosure herein. In the case of an unsupported library, every member (type molecule) is encoded with several tags (the number of tags depends on the size of the library and, in the best case scenario, N tags encode 2^{N} library compounds in binary code. In more general case each reagent for the library synthesis can be encoded by one tag, such that the total number of tags for encoding the full library is equal to the total number of building blocks used at synthetic steps. As an example: for a pentapeptide with 9 possible amino acid residues, the library has 9⁵=59,049 members encoded by 5×9=45 tags. The same 45 tags can encode a library of nearly two million nonapeptides with five possible residues: 5⁹=1,953,125). The kth library member Lₖ can be encoded with a set of tags {T}ₖ, for example, T₂, T₅, and T₇ in the following fashion: one fraction of Lₖ molecules are encoded with T₂, another fraction—with T₅ and yet another—with T₇, such that Lₖ is present in the solution as three populations: L-tether-T₂, Lₖ-tether-T₅, and Lₖ-tether-T₇. One example of a tag is a dithiane adduct with an aldehyde (or bis-adduct with an ester), which releases the dithiane in the case where a sensitizer is brought into vicinity. The remaining part of the fragmented adduct, benzaldehyde or aryloyldithiane, is not capable of sensitizing or carrying the amplification chain. A target compound (receptor) is modified by binding one or more sensitizers to form a target compound with tethered sensitizer. The sensitizer can be an electron-transfer sensitizer, for example a benzophenone or xanthone. The target compound with tethered sensitizer is incubated with the library. If Lₖ is the right ligand for it—it binds, effectively bringing the sensitizer in the vicinity of the tethered dithiane-benzaldehyde tags. After this incubation period the mixture is irradiated causing the tags that are in binding proximity of the protein to depart and be analyzed in the solution by conventional methods. For example, the solution is either extracted with a non polar organic solvent (in the case when lipophilic tags are used) and subjected to GCMS analysis, or injected as it is into LC/MS-ESI, in case of water-soluble tags. Since the identity of the particular releasable tags that were released by the association with the target compound with tethered sensitizer is known, the library member that was initially attached to the releasable tags can be determined (selected library member). This indicates that the target has stronger association with the selected library member than the other library members and is, therefore, a basis for identifying the best ligand.

Alternative initiators, for example, derivatives of quinones, including anthraquinone, can be used in these applications. In fact, even non-ketone based sensitizers can initiate the fragmentation; one example is dinitriles, such as dicyanobenzene, dicyanonaphthalene and dicyanoanthracene.

### Example 2

This embodiment is designed specifically for non-polar tags, not soluble in water. In this embodiment the library and the receptors are prepared as described in Example 1. The library is then solubilized by adding a micelle forming agent, for example, DPC (dodecylphosphocholine) in a proportion that ensures that each library member statistically occupies one micelle (approximately 60 molar equivalents of DPC to one molar equivalent of a tagged library member). The library is incubated with the sensitizer-tethered receptor as described above, and irradiated. The lipophilic dithiane tags that accumulate in the micelles “housing” the winning ligands as a result of photoinduced fragmentation are extracted with organic solvent, for example pentane, and analyzed by an appropriate method, for example GCMS. In this example, the water soluble ligands are displayed outside micelles, whereas the tags (for example, dithiane adducts) are located inside the micelles. In this embodiment a GCMS method is described that can be used for analysis of alkyldithiane-based tags and thus is applicable to all the embodiments described in this disclosure.

There are several advantages to this procedure: (i) photoinduced fragmentation is more efficient in the organic media (hydrophobic micelle environment); (ii) the tags are simply extracted with organic solvents; micelles shuttle the tags to the aqueous/organic boundary; (iii) the tethered tag, “hidden” inside the micelle does not interfere with molecular recognition taking place at the aqueous interface.

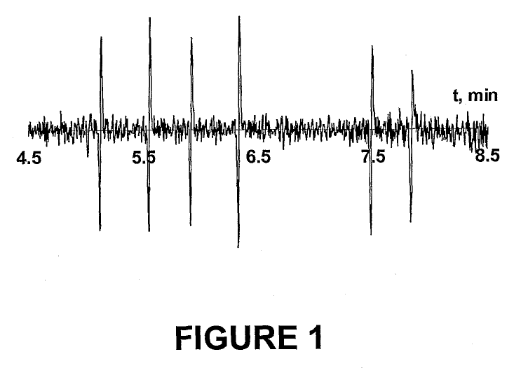

A series of alkyldithiane tags-2-methyl-1,3-dithiane through 2-decyl-1,3-dithiane was synthesized and a GCMS method for their detection in sub-picomolar amounts was optimized. The method is based on the so-called “single ion” monitoring, which allows monitoring two ions, 74 and 119, common for all the dithianes in the series. The 10 tags' retention times were 5.13; 5.56; 5.93; 6.34; 6.77; 7.15; 7.49; 7.84; 8.23 and 8.62 min, respectively. The decimal number 207 was encoded in binary form 0011001111. The chromatogram shown in FIG. 1 shows the first derivative of the total ion current (i.e. sum of I₇₄ and I₁₁₉)—decoding 207 was encoded with more than 10:1 signal to noise ratio for an injection, where only 500 femtomoles of a given dithiane was actually injected. The most remarkable result was that the chromatogram was obtained on a vintage 8-year-old HP GCMS. This demonstrates that dithiane tags can be confidently detected with ubiquitous laboratory equipment in sub-picomolar amounts.

### Example 3

The same approach is applicable to libraries immobilized on dendrimers and other supports. Again, the advantage is that such support beads/particles, however small, need not be mechanically handled.

An important distinction of this invention is that the selected library member is identified based on the material released into the solution which is detected. This allows for utilization of dendrimers and other particles for combinatorial screening. There are numerous advantages of dendrimer based libraries [see for example, Kim, R. M; Mahua, M.; Hutchings, S. M.; Griffin, P. R.; Yates, N. A.; Bernick, A. M.; Chapman, K. N. Proc. Natl. Acad. Sci. USA, 1996, 93, 10012-10017]. The single major obstacle in the dendrimer applications for combinatorial libraries is assaying them. Most of the binding assays are based on fluorescence imaging of beads and mechanical isolation of them, followed by analysis. Mechanical separation of a single dendrimer molecule is not possible, hence—the bottleneck. The method of assaying for binding described herein does not require mechanical isolation and therefore is applicable to very small particles or individual molecules.

In this embodiment, a one bead-one compound type library is synthesized using a dendrimer or nano/micro particle as support and tagged appropriately with dithiane-aldehyde or dithiane-ester adducts tethered through the framework of the carbonyl component to same dendrimer or nano/micro particle, as described above. The library is incubated with the sensitizer-tethered receptor as described above, and irradiated, causing release of the dithiane tags found on the dendrimer in the vicinity of the bound receptor. The tags are analyzed to identify the “winning” ligand, which bound to the receptor.

In another embodiment, one molecule of a dendrimer serves as a support for many molecules of one library member and all the tags necessary to encode this library member. A different molecule of a dendrimer serves as a support for many molecules of another library member and all the tags necessary to encode this library member, and so on. The dendrimers are brought into contact with the target compound with tethered sensitizer, and the analysis is performed as described herein.

### Example 4

The photocleavable chemistry need not be based solely on dithiane-carbonyl adducts. If the sensitizer is of electron-transfer type, any system capable of fragmenting upon formation of cation-radical or anion-radical can be employed, as long as it does not undergo premature photoinduced fragmentation in the absence of sensitizer. Examples include mesolytic fragmentations in vicinal diols, ethers, amino alcohols, etc. These systems are known in the art.

### Example 5

This embodiment exemplifies a specific method for tagging the libraries using the azide-alkyne copper-catalyzed coupling (the copper-catalyzed coupling of azides and alkynes is known in the art as an example of click chemistry, a term introduced by Barry Sharpless to indicate a reaction which occurs under very mild conditions with high rates and high degree of conversion with no complications). The armed tag-carrying bis-dithiane adduct is coupled with a ω-alkyne amine (Scheme 5). Scheme 5 shows synthesis of the “armed” tag module having an alkyne tether, where R′ is an encoding alkyl group, for example. n=1 to the largest repeat that can be prepared and function as described herein. One embodiment is n=1 to 30.

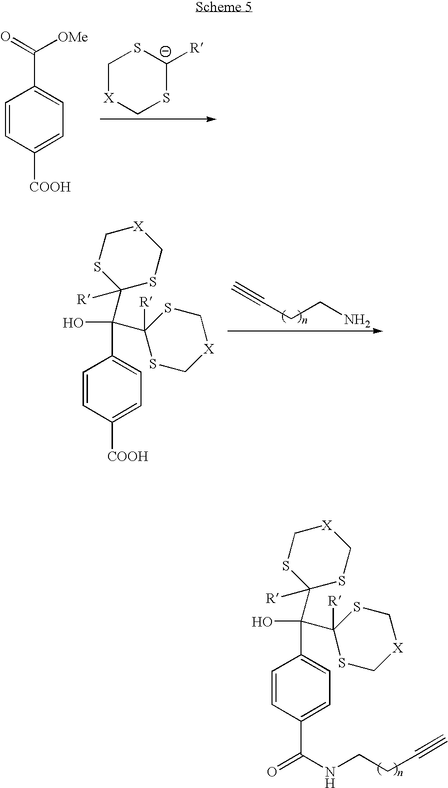

Scheme 6 illustrates building a library, while encoding each library member with a bis-dithiane based tag tethered via a copper-catalyzed cycloaddition of acetylenes and azides. n and m are independently 1 to the largest repeat that can be prepared and function as described herein. In one embodiment, n and m are independently from 1 to 30. Azidoacetic acid is coupled with co-aminoalkanoic acid (for example, as shown in Scheme 6) and the library is prepared by tethering the first element to the free carboxylate. As library synthesis continues, the elements are encoded by addition of appropriate amounts the acetylene-terminated tag-carrying bis-dithiane adduct and Cu-catalyzed coupling. The individual tags are added in the amounts of approx. 1/N molar equivalent for the case when the total of N tags is used to encode the library.

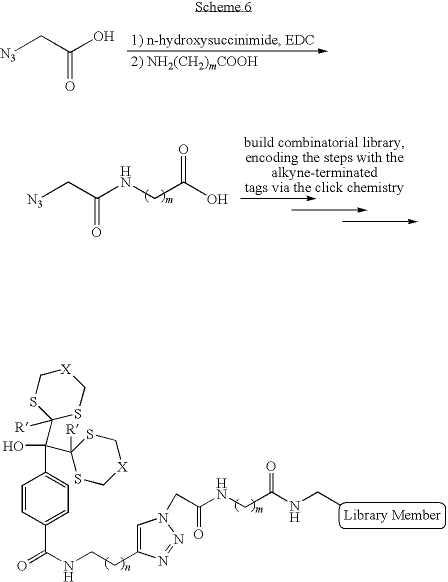

This invention is not limited to the azide-alkyne coupling to tag the library members as the library is being synthesized. Many other chemistries are applicable for linking the tags to the library members, including but not limited to carbodiimide-mediated amide/peptide bond formation, Staudinger ligation, nucleophilic substitutions, electrophilic additions, cycloadditions etc., as long as the chemistry does not interfere with the synthesis of the library. These and other coupling methods are well known in the art that can be used in the invention.

### Example 6

A central feature of the invention is that a molecular recognition event brings two moieties—the sensitizer and the dithiane-aldehyde/ketone adduct (or other cleavable moiety)—into proximity with each other, so that the sensitizer can induce the fragmentation and release dithiane or other cleavable tag. Scheme 7 shows an example of DNA/oligonucleotide detection. In this example the dithiane-ketone/aldehyde adduct is immobilized on a surface of a chip or other substrate via the carbonyl component, while the dithiane is carrying an oligonucleotide capable of forming a hairpin loop, and terminated by a tethered sensitizer (Scheme 7), such that the sensitizer (for example, benzophenone) is in immediate proximity of the dithiane-ketone/aldehyde photolabile tether (armed state). If a complementary nucleotide is present in the tested solution, it binds unfolding the hairpin, which effectively separates the sensitizer and the dithiane adduct (disarmed state). Irradiation of the initial armed state induces fragmentation and only the aromatic carbonyl compound stays tethered to the surface. In the case of the “disarmed state” (i.e. positive test result) there is no fragmentation. The detection can be electrochemical. The initial armed state has dithiane with low oxidation potential, which is close to the surface. If the test is “negative” (i.e. no complementary nucleotide is present in the solution), irradiation will cause fragmentation, with dithiane departing into the solution, so the oxidation potential of the material immobilized on the surface increases. The “positive” result (i.e. a complementary nucleotide is found in the solution) is no change in the oxidation potential.

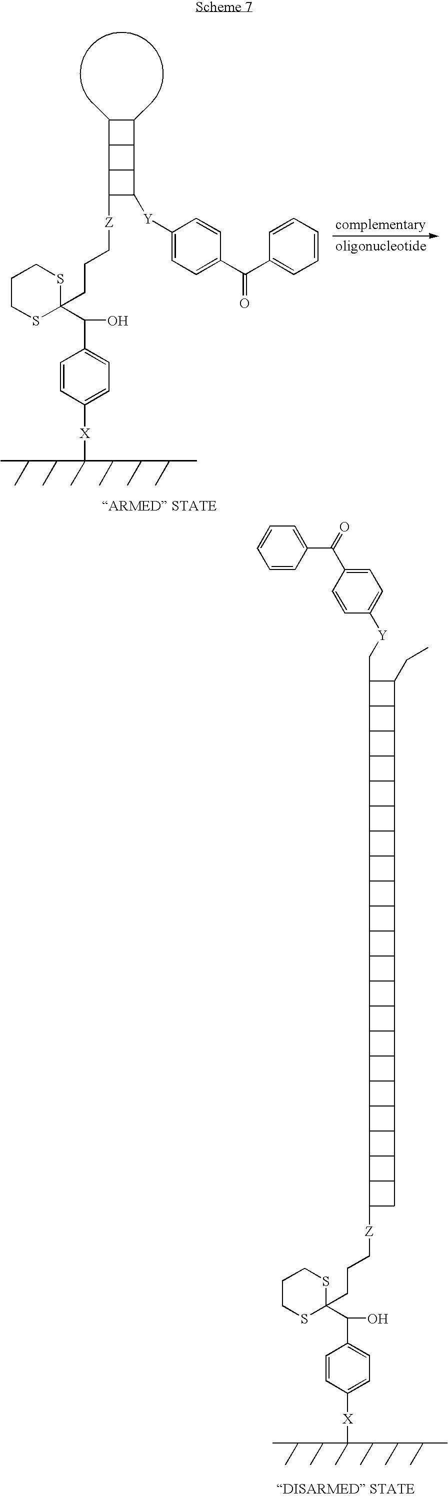

A surface-immobilized spatially addressable array is another embodiment, i.e. different nucleotide hairpins occupy different spatial positions on the grid with known coordinates. The invention is then carried out as described herein.

### Example 7

It is also beneficial to combine the advantages associated with the synthetic aspects of bead-supported libraries, i.e. the use of excess reagents that are washed out, no column purification etc., and the advantage of having unsupported library for screening, i.e. devoid of surface interference etc. One of the possible implementations of this hybrid methodology (supported synthesis—unsupported screening) is shown in Scheme 8. Scheme 8 shows one embodiment of the invention using amino-azides.

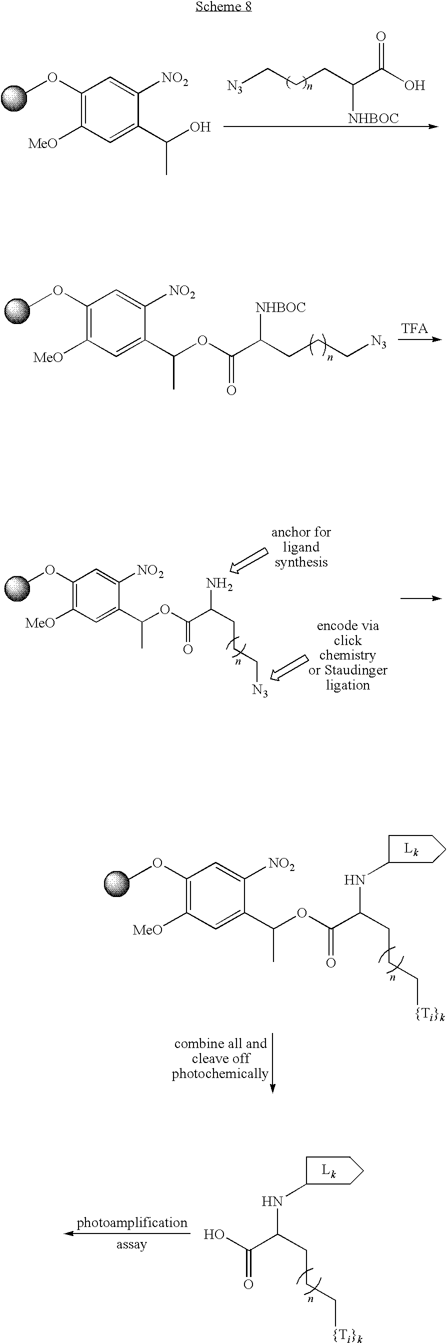

Photolabile linkers based on o-nitroveratryls were described for PAMAM dendrimers and polymeric beads [(a) Åkerblom, E. B. Six New Photolabile Linkers for Solid-Phase Synthesis. 2. Coupling of Various Building Blocks and Photolytic Cleavage. Mol. Divers. 1998, 4, 53-69. (b) Åkerblom, E. B.; Nygren, A. S.; Agback, K. H. Six New Photolabile Linkers for Solid-Phase Synthesis. 1. Methods of Preparation. Mol. Divers. 1998, 3, 137-148.] Synthesis of ω-azido-α-amino acids, N3-(CH2)n—CH(NH2)COOH, are well documented by Tirrell's and other groups. [(a) Presentation and detection of azide functionality in bacterial cell surface proteins. Link, A. J.; Vink, M. K. S.; Tirrell, D. A. J. Am. Chem. Soc. 2004, 126(34), 10598-10602. (b) Asymmetric alkylations of a sultam-derived glycine equivalent: practical preparation of enantiomerically pure α-amino acids. Oppolzer, W.; Moretti, R.; Zhou, C. Helv. Chim. Acta 1994, 77(8), 2363-80.]

Immobilized amino-azides shown, for example, in Scheme 8 can be used for combinatorial library synthesis and simultaneous encoding. Once the library is synthesized via the classical split-pool method, it is combined and cleaved off the polymeric support, releasing the members which are now present in several sub-populations, as shown in Scheme 4. Photoinduced release of library members from solid support does not affect the dithiane-based tags, because they are not capable of fragmenting in the absence of external sensitizer. Alternatively, other photolabile or non-photochemical linkers can be used to temporarily immobilize the tagged ligands for the duration of synthesis/tagging—this chemistry is well developed in the art.

Scheme 9 shows another example of the “supported synthesis—unsupported screening” concept, where the dynamic encoding is done via the azide chemistry (either Staudinger ligation or Sharpless' click chemistry).

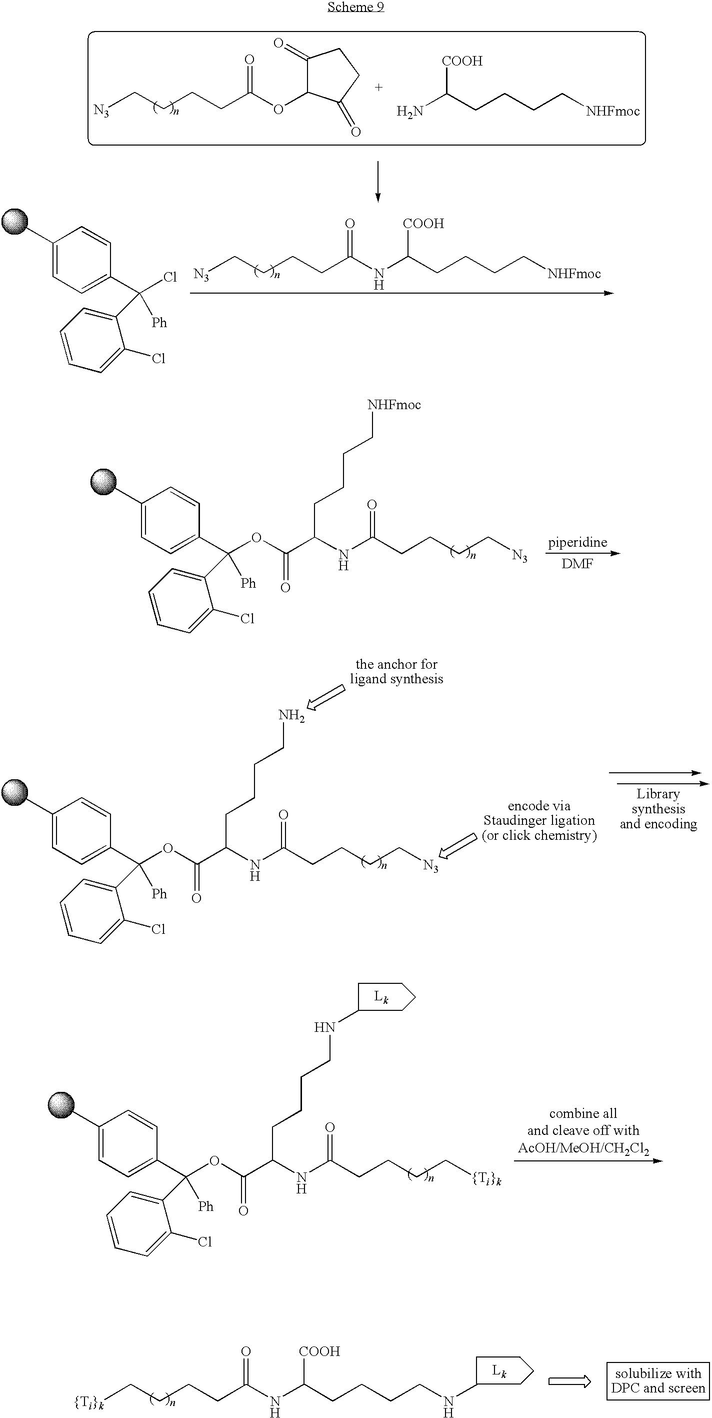

### Example 8

### Host-Guest Example

The adducts of 2-alkyl dithianes and 4-formylbenzoic acid were chosen as tagging modules because alkyl dithianes add readily to non-enolizable aromatic aldehydes and the carboxylate serves as a practical handle to tether the tag to a ligand. A series of N-hydroxysuccinimide esters 3a-i were synthesized as shown in Scheme 10A.

The archetype host-guest system, biotin-avidin, was chosen as an example. A model mini-library comprising three members was synthesized (Scheme 10B-D), each encoded with a set of three dithiane tags: a carboxylate 4e,g,h encoded with 2-pentyl, 2-heptyl and 2-octyl dithianes (decimal 208; binary 11010000), a sugar 6b,c,d (ethyl-, propyl- and butyl; 14; 1110), and biotin 10a,f,i (methyl-, hexyl- and nonyl; 289; 100100001). In this model library the encoding of individual members was intended not to overlap for demonstration purposes.

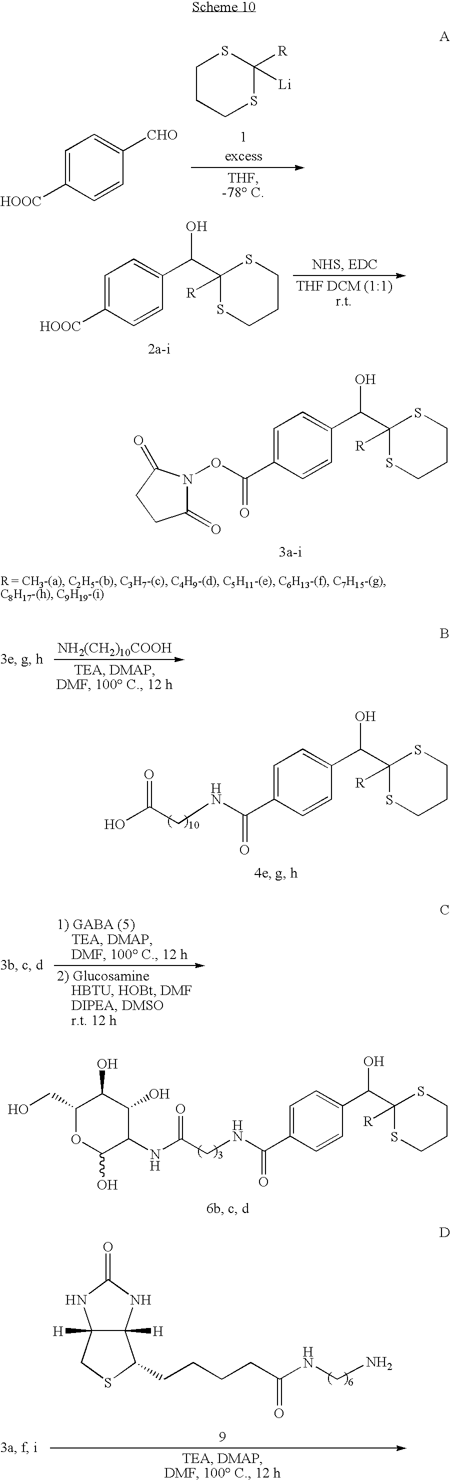

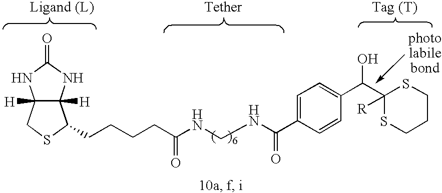

The receptor, ImmunoPure® avidin (Pierce), was outfitted with xanthone as an ET-sensitizer. The N-hydroxysuccinimide ester of 11-(xanthone-2-carboxamido)undecanoic acid was coupled to avidin in a 20 mM sodium phosphate buffer according to a described procedure (Wilchek, Methods Enzymol), with subsequent purification on a Sephadex G-25 column. The degree of immobilization was quantified by UV spectroscopy to be 0.77, indicating that on average each tetramer of avidin was carrying approximately three tethered xanthone carboxylates. Tethering the xanthone-based sensitizer to avidin is no different from outfitting a receptor with a fluorophore for the conventional on-the-bead fluorescence-guided assays.

The screening volume was compartmentalized with micellar detergent, dodecyl phosphocholine (DPC), preventing indiscriminant collisional quenching of avidin-tethered xanthone by unbound molecules and thus limiting the ET sensitization exclusively to the bound host-guest complex. Besides the fact that amphiphiles displaying phosphocholine are common in biological settings, utilization of DPC micelles offers a number of additional benefits: (i) it ensures that the screening is always compatible with aqueous media, regardless of aqueous solubility of the tested libraries; (ii) it allows the design of the tagging system to be centered around readily available hydrophobic alkyl dithianes, which can be selectively extracted after irradiation with hexane or other non-polar solvents for unobstructed GCMS analysis; (iii) it spatially segregates the photofragmentation chemistry from molecular recognition, eliminating potential interference between them; (iv) it restricts the photochemistry to the micelle interior improving quantum efficiency of fragmentation, as it is known to increase in the non-polar environment; and, finally, (v) the micelle-assisted design offers an option of solubilizing certain target proteins, which are not water soluble. While not an issue with avidin, this functionality may be important in assaying insoluble membrane proteins, as recognized in the art.

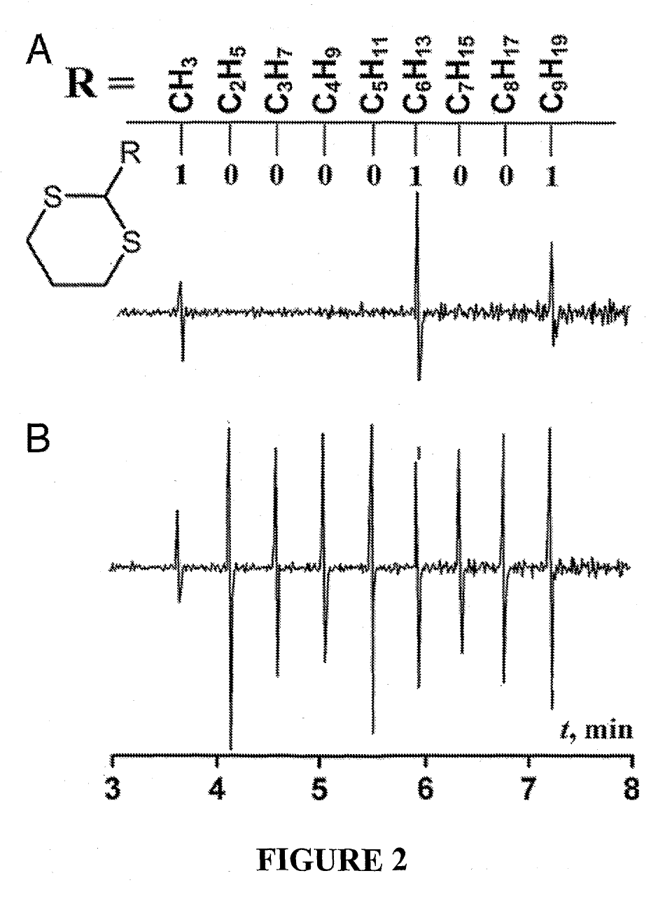

A typical screening procedure involved solubilization of the mini-library, approximately 0.5 mg per tagged compound, in a 0.6 mL aqueous solution containing 60 mg of DPC. To this clear micellar solution 0.5 mL of avidin-xanthone conjugate was added, so the final concentrations were 0.7 mM of each library member carrying one tag (6.3 mM total), 23 μM protein and 155 mM DPC. The micelle-embedded molecules had apparent translational diffusion coefficients of 7×10⁻⁷ cm²s⁻¹, as measured with spin-echo pulse field gradient (PFG) ¹H NMR. This corresponds to the hydrodynamic radius of ˜3 nm, indicating that the occupied DPC micelles did not deviate much from their original 5-5.5 nm size. The resulting micellar solution was incubated in an orbital shaker for 1 hour, purged with argon for 45 min, and irradiated for 4 hours, using a 335 nm long pass filter. Then the mixture was extracted with 0.5 mL of hexane, concentrated to 100 μL and analyzed by GCMS. FIG. 2 clearly shows that only the biotin encoding tags, namely methyl-, hexyl- and nonyl-dithianes (binary 100100001, read from left to right), were detected in the chromatogram. The other six dithiane tags encoding glucosamine and aminoundecanoic acid were not discernible at all, attesting to the high fidelity of the assay.

The integrated intensity of dithiane peaks in most experiments was comparatively uniform within 30-50%. The quantum yield of alkyldithiane photo-release from ketone adducts increases in small increments of 2-3% in a homologous series, leveling off for the higher alkyls (Gustafson). The GCMS sensitivity of dithianes detection also varies insignificantly. If needed, these small variations can be offset by adjusting the quantities of individual tags used for encoding of each step.

To demonstrate that the compartmentalization requirement is not necessarily strict, one micelle in the described screening experiment contained on average two tagged library molecules (assuming that the aggregation number of DPC is 50-60 (Brown)). In theory, if the protein-tethered sensitizer indiscriminately releases both tags from the two occupants of the bound micelle, the integrated intensity of the false peaks in the chromatogram should constitute more than one third of the correct peak's intensity. Experimentally no false tags were detected, with the signal to noise ratio of the SIM ion current exceeding 20:1. This either shows that the sensitizer discriminates between the bound and non-bound occupants of the micelle, preferentially triggering the release of the bound tag, or that the micelles containing two biotin molecules bind much better than the micelles containing only one biotin, in which case false release is not at all possible. It is also conceivable that both factors operate concurrently, improving the fidelity of the method. If needed, a one molecule—one micelle compartmentalization can be readily achieved in practice by increasing the detergent concentration.

The generality of this approach is not limited to the tagging assemblies based on dithiane-aldehyde adducts. Potentially, any externally sensitized fragmentation reaction can be utilized in such binding assays. Similar results were achieved with different tags comprised of thio ortho esters, 2-alkylthio-dithianes (Valiulin). The model mini-library was tagged with nine thio ortho esters (19), three tags per library member, with biotin encoded by a different decimal 261, binary 100000101 (Scheme 11). The DPC micellar solution of the library was incubated with the avidin-xanthone conjugate, irradiated and extracted with hexane. The GCMS trace again showed only the dithianes encoding biotin. None of the other six dithianes were detected in the hexane extract after irradiation.

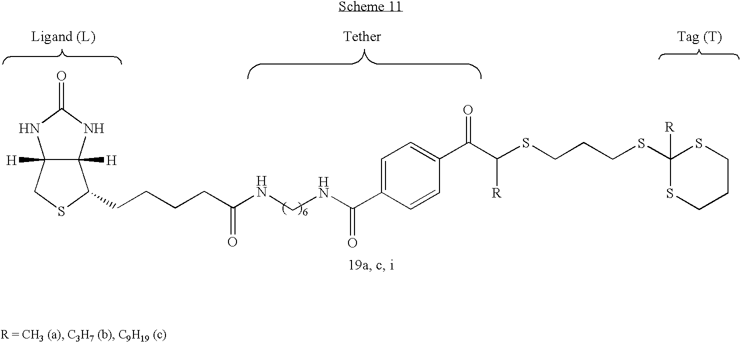

### Example 9

### Dynamic Tagging Example

Dynamic encoding of libraries, prepared via the split-pool approach, is normally achieved with a coupling scheme orthogonal to the employed synthetic steps. The tagging synthons, esters 3, can be coupled with the library molecules via tethers containing primary amino groups, as in conventional polypeptide encoding (Franz, Liu), which involves the appropriate cycling of the BOC or FMOC protection. Alternatively, the esters 3 can be used for dynamic tagging in conjunction with other efficient coupling reactions, such as Staudinger ligation (Saxon-Science, Saxon-Org. Lett., Nilsson) or Sharpless' click chemistry (Kolb).

To this end 3a was coupled with propargyl amine, providing the acetylenic tagging component S20 for the azide-acetylene click pair. Another readily available tag series was prepared from commercially available acetylenic benzaldehyde as shown in Scheme 12. The Staudinger ligation produces the benzamide linkage, found in compounds 4, 6 and 10, for example. Acetylene-azide click chemistry yields triazoles. Methyl 10-azidodecanoate, emulating an azide-tethered library member, was “clicked” onto adduct 21 forming triazole 22, which upon benzophenone sensitization released methyl dithiane with a quantum efficiency very similar to the parent (unsubstituted) benzaldehyde adduct. Triazole 22 was unchanged after prolonged irradiation in the absence of the ET-sensitizer, showing no self-cleavage at wavelengths above 330 nm. This is a critically important finding because premature self-cleavage is detrimental to screening, as it produces false positives.

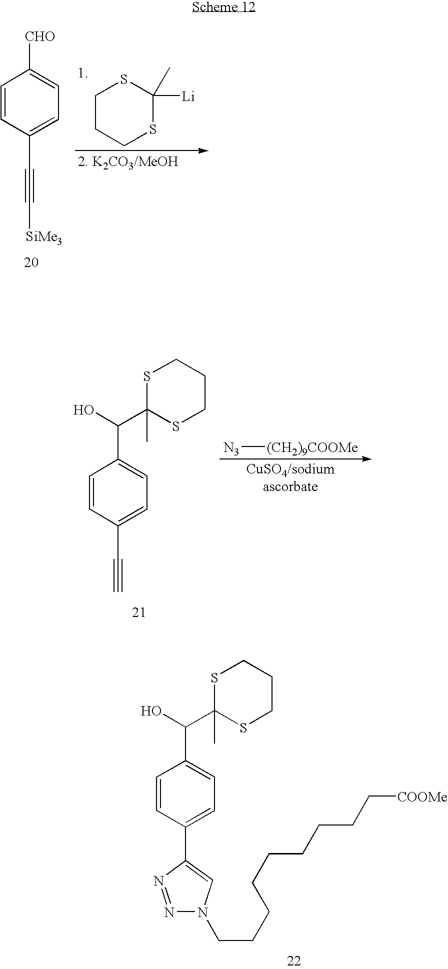

### Materials and Methods

Common reagents were purchased from the Sigma-Aldrich Chemical Co. and used without further purification. THF was refluxed over and distilled from potassium benzophenone ketyl prior to use. Immunopure Avidin was purchased from Pierce. ¹H and ¹³C NMR spectra were recorded at 25° C. on a Varian Mercury 400 MHz instrument, in CDCl₃, DMSO-d₆ or CD₃OD using TMS used as an internal standard. Pulsed Field Gradient NMR studies were carried out with the Varian Performa I PFG module and a 4-nuclei auto-switchable PFG probe. Column chromatography was performed on silica gel, 70-230 mesh. The UV-Vis spectra were recorded on a Beckman DU-640 spectrophotometer. Irradiations were carried out in a carousel Rayonet photo reactor (RPR-3500 lamps) and a 330 nm long pass solution filter. Gas chromatography was done using a Varian Saturn 2100 T Ion-Trap GCMS utilizing Electron Ionization (EI). Selective ion monitoring m/z 119, 74 was used to separate dithiane tags following fragmentation. The initial temperature was 70° C. and a final temperature of 260° C. was reached at the rate of 300 C/min. The inlet temperature was 100° C. and the split ratio was 100. The flow rate was 1.0 mL/min with column dimensions of 30 m×250 μm ID, as well as a 5% phenyl methyl siloxane fused silica bonded capillary.

General Procedure for Syntheses of 1(b-i)

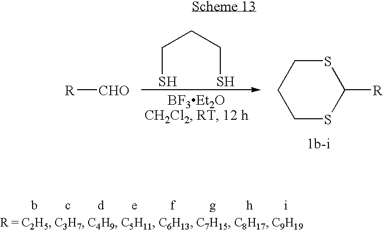

To a solution of substituted aldehyde (66.9 mmol) and 1,3-propanedithiol (66.9 mmol) in methylene chloride (300 mL) was added BF₃*Et₂O (0.268 mol) and stirred for 12 h at 25° C. The reaction mixture was washed with NaOH (2×200 mL, 5% aq. soln) and H₂O (300 mL). The organic layer was dried over anhydrous Na₂SO₄ and the solvent was removed under vacuum and dried to obtain the desired compound.

1b, 91% Yield.

¹H NMR (CDCl₃, 400 MHz): δ 4.01 (t, J=6.79 Hz, 1H), 2.92-2.81 (m, 4H), 2.18-2.09 (m, 1H), 1.91-1.76 (m, 3H), 1.10 (t, J=7.44 Hz, 3H);

1c, 87% Yield.

¹H NMR (CDCl³, 400 MHz): δ 4.08 (t, J=6.93 Hz, 1H), 2.92-2.79 (m, 4H), 2.15-2.08 (m, 1H), 1.91-1.80 (m, 1H), 1.75-1.70 (m, 2H), 1.57-1.48 (m, 2H), 0.95 (t, J=7.32 Hz, 3H);

1d, 82% Yield.

¹H NMR (CDCl₃, 400 MHz): δ 4.06 (t, J=6.90 Hz, 1H), 2.92-2.79 (m, 4H), 2.15-2.08 (m, 1H), 1.91-1.81 (m, 1H), 1.78-1.72 (m, 2H), 1.52-1.45 (m, 2H), 1.38-1.29 (m, 2H), 0.92 (t, J=7.29 Hz, 3H);

1e, 94% Yield.

¹H NMR (CDCl₃, 400 MHz): δ 4.03 (t, J=6.90 Hz, 1H), 2.92-2.79 (m, 4H), 2.15-2.08 (m, 1H), 1.92-1.80 (m, 1H), 1.77-1.71 (m, 2H), 1.56-1.47 (m, 2H), 1.36-1.26 (m, 4H), 0.91 (t, J=6.95 Hz, 3H);

1f, 86% Yield.

¹H NMR (CDCl₃, 400 MHz): δ 4.07 (t, J=6.90 Hz, 1H), 2.92-2.79 (m, 4H), 2.15-2.08 (m, 1H), 1.92-1.83 (m, 1H), 1.77-1.72 (m, 2H), 1.54-1.46 (m, 2H), 1.34-1.24 (m, 6H), 0.90 (t, J=6.79 Hz, 3H);

1g, 91% Yield.

¹H NMR (CDCl₃, 400 MHz): δ 4.06 (t, J=6.90 Hz, 1H), 2.91-2.78 (m, 4H), 2.14-2.07 (m, 1H), 1.91-1.80 (m, 1H), 1.76-1.71 (m, 2H), 1.51-1.45 (m, 2H), 1.31-1.22 (m, 8H), 0.89 (t, J=6.95 Hz, 3H);

1h, 93% Yield.

¹H NMR (CDCl₃, 400 MHz): δ 4.05 (t, J=6.89 Hz, 1H), 2.91-2.78 (m, 4H), 2.13-2.08 (m, 1H), 1.89-1.82 (m, 1H), 1.76-1.70 (m, 2H), 1.52-1.45 (m, 2H), 1.30-1.23 (m, 10H), 0.88 (t, J=6.82 Hz, 3H);

1i, 90% Yield.

¹H NMR (CDCl₃, 400 MHz): δ 4.06 (t, J=6.89 Hz, 1H), 2.91-2.78 (m, 4H), 2.15-2.08 (m, 1H), 1.91-1.80 (m, 1H), 1.76-1.70 (m, 2H), 1.52-1.47 (m, 2H), 1.32-1.22 (m, 12H), 0.89 (t, J=6.88 Hz, 3H);

General Procedure for Syntheses of 2(a-i)

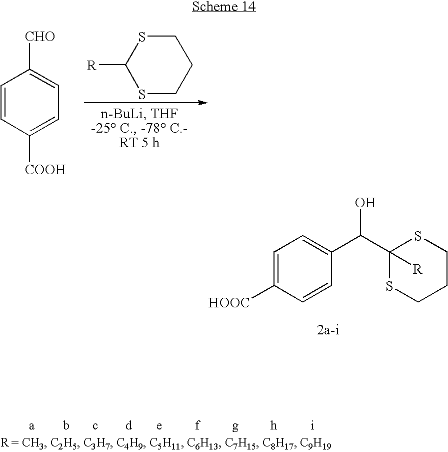

n-BuLi (14.58 mL, 23.3 mmol, 1.6 M solution in THF) was added at −25° C. to a solution of 2-alkyl-1,3-dithiane (23.3 mmol) in dry THF (40 mL) under nitrogen atmosphere. The resulting solution was stirred at this temperature for 2 h, the temperature was then reduced to −78° C. and 4-formylbenzoic acid (0.5 g, 3.33 mmol) in 20 mL of THF was added. After stirring at −78° C. for an additional 2 hr, the solution was allowed to warm to room temperature. Saturated ammonium chloride (20 mL) was added, and the aqueous phase was extracted twice with 20 mL ethyl acetate. The aqueous layer was acidified with 5% HCl, extracted with ethyl acetate (100 mL), dried over Na₂SO₄ and the solvent was removed in vacuum. The crude product was crystallized from toluene to get pure compound.

2a, 95% Yield.

¹H NMR (DMSO-d₆, 400 MHz): δ 7.85 (d, J=8.34 Hz, 2H), 7.53 (d, J=8.34 Hz, 2H), 5.76 (d, J=4.50 Hz, 1H), 4.97 (d, J=4.41 Hz, 1H), 3.14-2.99 (m, 2H), 2.71-2.67 (m, 2H), 1.91 (m, 1H), 1.77 (m, 1H), 1.30 (s, 3H);

¹³C NMR (DMSO-d₆, 100 MHz): δ 167.99, 146.61, 130.35, 129.31, 128.63, 77.95, 53.59, 26.83, 26.52, 25.13, 23.96.

2b, 96% Yield.

¹H NMR (DMSO-d₆, 400 MHz): δ 7.85 (d, J=8.34 Hz, 2H), 7.56 (d, J=8.34 Hz, 2H), 5.68 (d, J=4.50 Hz, 1H), 5.00 (d, J=4.41 Hz, 1H), 3.06-2.99 (m, 1H), 2.91-2.84 (m, 1H), 2.70-2.58 (m, 2H), 1.85-1.76 (m, 2H), 1.73-1.66 (m, 1H), 1.57-1.52 (m, 1H), 0.99 (t, J=7.4 Hz, 3H);

¹³C NMR (DMSO-d₆, 100 MHz): δ 168.00, 146.85, 130.24, 129.57, 128.49, 77.29, 58.95, 29.13, 26.46, 25.91, 24.86, 9.81.

2c, 94% Yield.

¹H NMR (DMSO-d₆, 400 MHz): δ 7.85 (d, J=8.40 Hz, 2H), 7.55 (d, J=8.28 Hz, 2H), 5.68 (d, J=4.50 Hz, 1H), 5.01 (d, J=4.50 Hz, 1H), 3.06-3.03 (m, 1H), 2.90-2.87 (m, 1H), 2.68-2.59 (m, 2H), 1.84-1.83 (m, 1H), 1.72-1.66 (m, 2H), 1.51-1.40 (m, 3H), 0.82 (t, J=7.17 Hz, 3H);

¹³C NMR (DMSO-d₆, 100 MHz): δ 168.01, 146.82, 130.25, 129.54, 128.52, 77.32, 58.37, 38.63, 26.64, 26.09, 24.90, 18.16, 15.05.

2d, 92% Yield.

¹H NMR (DMSO-d₆, 400 MHz): δ 7.85 (d, J=8.32 Hz, 2H), 7.55 (d, J=8.28 Hz, 2H), 5.68 (d, J=4.48 Hz, 1H), 5.01 (d, J=4.44 Hz, 1H), 3.08-3.03 (m, 1H), 2.92-2.87 (m, 1H), 2.68-2.58 (m, 2H), 1.86-1.66 (m, 3H), 1.49-1.40 (m, 3H), 1.21-1.16 (m, 2H), 0.83 (t, J=7.31 Hz, 3H);

¹³C NMR (DMSO-d₆, 100 MHz): δ 168.00, 146.86, 130.24, 129.55, 128.49, 77.33, 58.32, 36.11, 26.96, 26.62, 26.08, 24.90, 23.31, 14.64.

2e, 96% Yield.

¹H NMR (DMSO-d₆, 400 MHz): δ 7.84 (d, J=8.10 Hz, 2H), 7.55 (d, J=8.21 Hz, 2H), 5.68 (d, J=4.45 Hz, 1H), 5.01 (d, J=4.40 Hz, 1H), 3.05-3.00 (m, 1H), 2.92-2.87 (m, 1H), 2.67-2.58 (m, 2H), 1.84-1.67 (m, 3H), 1.45-1.40 (m, 3H), 1.25-1.15 (m, 4H), 0.83 (t, J=7.04 Hz, 3H);

¹³C NMR (DMSO-d₆, 100 MHz): δ 167.99, 146.86, 130.23, 129.54, 128.49, 77.32, 58.36, 36.30, 32.39, 26.62, 26.08, 24.89, 24.37, 22.70, 14.59.

2f, 92% Yield.

¹H NMR (DMSO-d₆, 400 MHz): δ 7.84 (d, J=7.96 Hz, 2H), 7.55 (d, J=7.90 Hz, 2H), 5.67 (d, J=4.25 Hz, 1H), 5.01 (d, J=4.41 Hz, 1H), 3.08-3.02 (m, 1H), 2.92-2.87 (m, 1H), 2.67-2.58 (m, 2H), 1.83-1.67 (m, 3H), 1.46-1.40 (m, 3H), 1.21-1.15 (m, 6H), 0.83 (t, J=6.44 Hz, 3H);

¹³C NMR (DMSO-d₆, 100 MHz): δ 167.98, 146.86, 130.22, 129.54, 128.48, 77.32, 58.35, 36.37, 31.84, 29.81, 26.62, 26.08, 24.89, 24.66, 22.71, 14.59.

2g, 95% Yield.

¹H NMR (DMSO-d₆, 400 MHz): δ 7.84 (d, J=8.03 Hz, 2H), 7.55 (d, J=7.90 Hz, 2H), 5.66 (d, J=3.96 Hz, 1H), 5.00 (d, J=3.68 Hz, 1H), 3.05-3.02 (m, 1H), 2.90-2.87 (m, 1H), 2.67-2.57 (m, 2H), 1.85-1.66 (m, 3H), 1.45-1.40 (m, 3H), 1.27-1.19 (m, 8H), 0.83 (t, J=6.32 Hz, 3H);

¹³C NMR (DMSO-d₆, 100 MHz): δ 167.98, 146.85, 130.22, 129.52, 128.48, 77.33, 58.35, 36.37, 31.88, 30.11, 29.28, 26.64, 26.09, 24.90, 24.69, 22.74, 14.62.

2h, 91% Yield.

¹H NMR (DMSO-d₆, 400 MHz): δ 7.84 (d, J=8.36 Hz, 2H), 7.53 (d, J=8.32 Hz, 2H), 5.65 (brs, 1H), 5.00 (s, 1H), 3.08-3.02 (m, 1H), 2.92-2.87 (m, 1H), 2.67-2.57 (m, 2H), 1.86-1.63 (m, 3H), 1.45-1.40 (m, 3H), 1.29-1.19 (m, 10H), 0.84 (t, J=6.85 Hz, 3H);

¹³C NMR (DMSO-d₆, 100 MHz): δ 168.06, 146.69, 130.55, 129.48, 128.47, 77.37, 58.35, 36.38, 31.93, 30.14, 29.56, 29.30, 26.65, 26.10, 24.89, 24.67, 22.77, 14.63.

2i, 90% Yield.

¹H NMR (DMSO-d₆, 400 MHz): δ 7.84 (d, J=8.29 Hz, 2H), 7.55 (d, J=8.32 Hz, 2H), 5.67 (d, J=4.48 Hz, 1H), 5.01 (d, J=4.44, 1H), 3.06-3.02 (m, 1H), 2.90-2.87 (m, 1H), 2.67-2.57 (m, 2H), 1.84-1.66 (m, 3H), 1.45-1.39 (m, 3H), 1.24-1.19 (m, 12H), 0.84 (t, J=6.84 Hz, 3H);

¹³C NMR (DMSO-d₆, 100 MHz): δ 167.97, 146.81, 130.24, 129.51, 128.47, 77.38, 58.35, 36.38, 31.99, 30.17, 29.63, 29.37, 26.67, 26.13, 24.90, 24.67, 22.80, 14.62.

General Procedure for Syntheses of 3(a-i)

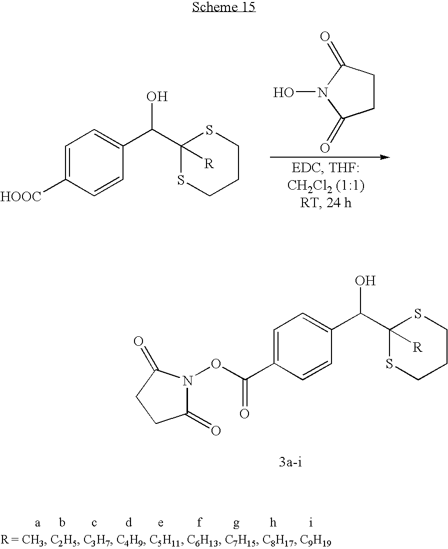

A mixture of 4-[(2-alkyl-1,3-dithian-2-yl)(hydroxyl)methyl]benzoic acid (1.60 mmol), N-hydroxysuccinimide (2.56 mmol) and EDC (2.08 mmol) was dissolved in THF:CH₂Cl₂ (1:1, 30 mL) and stirred for 24 h at room temperature. The solution was washed with 20 mL of water, 20 mL of saturated NaHCO₃, followed by 10 mL of brine. Then the solution was dried over anhydrous Na₂SO₄ and the solvent was evaporated in vacuum to give the desired compound.

3a, 97% Yield.

¹H NMR (CDCl₃, 400 MHz): δ 8.08 (d, J=8.46 Hz, 2H), 7.65 (d, J=8.50 Hz, 2H), 5.15 (s, 1H), 3.39 (brs, 1H), 3.24-3.17 (m, 1H), 3.10-3.03 (m, 1H), 2.89-2.85 (m, 4H), 2.75-2.65 (m, 2H), 2.65-2.16 (m, 1H), 1.92-1.88 (m, 1H), 1.21 (s, 3H);

¹H NMR (CD₃OD, 400 MHz): δ 8.02 (d, J=8.32 Hz, 2H), 7.70 (d, J=8.31 Hz, 2H), 5.92 (d, J=4.60 Hz, 1H), 5.07 (d, J=4.56 Hz, 1H), 3.19-3.13 (m, 1H), 3.09-3.03 (m, 1H), 2.88 (brs, 4H), 2.71-2.67 (m, 2H), 1.94-1.90 (m, 1H), 1.79-1.73 (m, 1H), 1.73 (s, 3H);

¹³C NMR (CD₃OD, 100 MHz): δ 171.02, 162.37, 149.67, 130.18, 129.33, 123.95, 77.50, 53.39, 26.84, 26.52, 26.24, 25.04, 23.94.

3b, 94% Yield.

¹H NMR (CDCl₃, 400 MHz): δ 8.07 (d, J=8.41 Hz, 2H), 7.67 (d, J=8.41 Hz, 2H), 5.21 (s, 1H), 3.46 (brs, 1H), 3.19-3.12 (m, 1H), 3.03-2.97 (m, 1H), 2.88-2.84 (m, 4H), 2.73-2.65 (m, 2H), 2.13-2.10 (m, 1H), 1.86-1.77 (m, 2H), 1.24-1.17 (m, 1H), 1.02 (t, J=7.41 Hz, 3H);

¹H NMR (CD₃OD, 400 MHz): δ 8.01 (d, J=8.52 Hz, 2H), 7.72 (d, J=8.39 Hz, 2H), 5.86 (d, J=4.62 Hz, 1H), 5.07 (d, J=4.63 Hz, 1H), 3.09-3.02 (m, 1H), 2.93-2.78 (m, 5H), 2.72-2.60 (m, 2H), 1.86-1.81 (m, 2H), 1.73-1.67 (m, 1H), 1.58-1.53 (m, 1H), 1.00 (t, J=7.36 Hz, 3H);

¹³C NMR (CD₃OD, 100 MHz): δ 171.04, 162.39, 149.95, 130.47, 129.19, 123.83, 76.88, 58.91, 29.05, 26.40, 26.23, 25.90, 24.81, 9.78.

3c, 97% Yield.

¹H NMR (CDCl₃, 400 MHz): δ 8.07 (d, J=8.04 Hz, 2H), 7.67 (d, J=8.08 Hz, 2H), 5.20 (s, 1H), 3.49 (brs, 1H), 3.19-3.13 (m, 1H), 3.03-2.97 (m, 1H), 2.87-2.82 (m, 4H), 2.71-2.63 (m, 2H), 2.13-2.10 (m, 1H), 1.86-1.67 (m, 2H), 1.53-1.50 (m, 2H), 1.13-1.06 (m, 1H), 0.82 (t, J=7.16 Hz, 3H);

¹H NMR (CD₃OD, 400 MHz): δ 8.02 (d, J=8.30 Hz, 2H), 7.72 (d, J=8.36 Hz, 2H), 5.85 (d, J=4.53 Hz, 1H), 5.09 (d, J=4.52 Hz, 1H), 3.11-3.06 (m, 1H), 2.97-2.80 (m, 5H), 2.78-2.65 (m, 2H), 1.87-1.70 (m, 3H), 1.52-1.41 (m, 3H), 0.81 (t, J=7.35 Hz, 3H);

¹³C NMR (CD₃OD, 100 MHz): δ 171.04, 162.39, 149.93, 130.44, 129.21, 123.83, 76.88, 58.32, 38.48, 26.57, 26.23, 26.12, 26.06, 24.84, 18.14, 15.03.

3d, 93% Yield.

¹H NMR (CDCl₃, 400 MHz): δ 8.06 (d, J=8.20 Hz, 2H), 7.66 (d, J=8.20 Hz, 2H), 5.19 (s, 1H), 3.49 (brs, 1H), 3.19-3.12 (m, 1H), 3.02-2.96 (m, 1H), 2.86-2.81 (m, 4H), 2.71-2.62 (m, 2H), 2.13-2.09 (m, 1H), 1.85-1.70 (m, 2H), 1.52-1.47 (m, 2H), 1.22-1.08 (m, 3H), 0.84 (t, J=7.16 Hz, 3H);

¹H NMR (CD₃OD, 400 MHz): δ 8.03 (d, J=8.23 Hz, 2H), 7.72 (d, J=8.38 Hz, 2H), 5.85 (d, J=4.57 Hz, 1H), 5.09 (d, J=4.60 Hz, 1H), 3.11-3.05 (m, 1H), 2.95-2.78 (m, 5H), 2.68-2.60 (m, 2H), 1.88-1.67 (m, 3H), 1.50-1.41 (m, 3H), 1.23-1.17 (m, 2H), 0.84 (t, J=7.30 Hz, 3H);

¹³C NMR (CD₃OD, 100 MHz): δ 171.04, 162.39, 149.95, 130.45, 129.19, 123.83, 76.91, 58.29, 36.00, 26.94, 26.58, 26.23, 26.06, 24.85, 23.28, 14.65.

3e, 94% Yield.

¹H NMR (CDCl₃, 400 MHz): δ 8.05 (d, J=8.10 Hz, 2H), 7.64 (d, J=8.15 Hz, 2H), 5.17 (s, 1H), 3.51 (brs, 1H), 3.17-3.11 (m, 1H), 3.01-2.94 (m, 1H), 2.84-2.79 (m, 4H), 2.69-2.60 (m, 2H), 2.10-2.07 (m, 1H), 1.83-1.68 (m, 2H), 1.50-1.47 (m, 2H), 1.26-1.06 (m, 5H), 0.82 (t, J=7.17 Hz, 3H);

¹H NMR (CD₃OD, 400 MHz): δ 8.06 (d, J=8.24 Hz, 2H), 7.72 (d, J=8.32 Hz, 2H), 5.84 (d, J=4.52 Hz, 1H), 5.10 (d, J=4.47 Hz, 1H), 3.12-3.05 (m, 1H), 2.96-2.84 (m, 5H), 2.70-2.58 (m, 2H), 1.89-1.67 (m, 3H), 1.55-1.40 (m, 3H), 1.27-1.14 (m, 4H), 0.83 (t, J=7.06 Hz, 3H);

¹³C NMR (CD₃OD, 100 MHz): δ 171.01, 162.39, 149.93, 130.44, 129.19, 123.85, 76.90, 58.34, 36.20, 32.37, 26.59, 26.24, 25.81, 24.84, 24.37, 22.72, 14.58.

3f, 97% Yield.

¹H NMR (CDCl₃, 400 MHz): δ 8.07 (d, J=8.15 Hz, 2H), 7.67 (d, J=8.14 Hz, 2H), 5.21 (s, 1H), 3.49 (brs, 1H), 3.20-3.14 (m, 1H), 3.04-2.98 (m, 1H), 2.90-2.86 (m, 4H), 2.72-2.60 (m, 2H), 2.14-2.11 (m, 1H), 1.90-1.70 (m, 2H), 1.50-1.47 (m, 2H), 1.39-1.12 (m, 7H), 0.85 (t, J=6.72 Hz, 3H);

¹H NMR (CD₃OD, 400 MHz): δ 8.02 (d, J=8.16 Hz, 2H), 7.72 (d, J=8.34 Hz, 2H), 5.84 (d, J=4.44 Hz, 1H), 5.09 (d, J=4.15 Hz, 1H), 3.11-3.06 (m, 1H), 2.95-2.79 (m, 5H), 2.69-2.57 (m, 2H), 1.88-1.67 (m, 3H), 1.52-1.41 (m, 3H), 1.25-1.11 (m, 6H), 0.83 (t, J=6.72 Hz, 3H);

¹³C NMR (CD₃OD, 100 MHz): δ 171.01, 162.38, 149.94, 130.43, 129.19, 123.84, 76.90, 58.33, 36.27, 31.87, 29.80, 26.59, 26.23, 26.08, 25.81, 24.84, 24.66, 22.72, 14.59.

3g, 92% Yield.

¹H NMR (CDCl₃, 400 MHz): δ 8.06 (d, J=8.35 Hz, 2H), 7.66 (d, J=8.35 Hz, 2H), 5.20 (s, 1H), 3.51 (brs, 1H), 3.19-3.13 (m, 1H), 3.03-2.97 (m, 1H), 2.90-2.87 (m, 4H), 2.71-2.62 (m, 2H), 2.13-2.09 (m, 1H), 1.89-1.69 (m, 2H), 1.51-1.48 (m, 2H), 1.38-1.07 (m, 9H), 0.84 (t, J=6.80 Hz, 3H);

¹H NMR (CD₃OD, 400 MHz): δ 8.02 (d, J=8.23 Hz, 2H), 7.72 (d, J=8.21 Hz, 2H), 5.83 (d, J=4.44 Hz, 1H), 5.09 (d, J=4.37 Hz, 1H), 3.12-3.05 (m, 1H), 2.96-2.80 (m, 5H), 2.69-2.57 (m, 2H), 1.88-1.67 (m, 3H), 1.51-1.41 (m, 3H), 1.27-1.16 (m, 8H), 0.83 (t, J=6.66 Hz, 3H);

¹³C NMR (CD₃OD, 100 MHz): δ 170.99, 162.38, 149.92, 130.42, 129.18, 123.85, 79.84, 76.91, 58.33, 36.27, 31.89, 30.10, 29.31, 26.60, 26.23, 24.84, 24.69, 22.75, 14.61.

3h, 94% Yield.

¹H NMR (CDCl₃, 400 MHz): δ 8.09 (d, J=8.27 Hz, 2H), 7.68 (d, J=8.56 Hz, 2H), 5.23 (s, 1H), 3.47 (brs, 1H), 3.23-3.16 (m, 1H), 3.07-3.00 (m, 1H), 2.90-2.85 (m, 4H), 2.75-2.67 (m, 2H), 2.17-2.14 (m, 1H), 1.90-1.71 (m, 2H), 1.52-1.47 (m, 2H), 1.38-1.08 (m, 11H), 0.87 (t, J=6.40 Hz, 3H);

¹H NMR (CD₃OD, 400 MHz): δ 8.02 (d, J=8.25 Hz, 2H), 7.73 (d, J=8.27 Hz, 2H), 5.81 (d, J=4.00 Hz, 1H), 5.10 (d, J=3.39 Hz, 1H), 3.12-3.07 (m, 1H), 2.96-2.79 (m, 5H), 2.68-2.58 (m, 2H), 1.86-1.70 (m, 3H), 1.49-1.40 (m, 3H), 1.26-1.10 (m, 10H), 0.82 (t, J=6.44 Hz, 3H);

¹³C NMR (CD₃OD, 100 MHz): δ 170.96, 162.37, 149.90, 130.41, 129.17, 123.87, 79.84, 76.92, 58.33, 36.26, 31.95, 30.17, 29.61, 29.33, 26.63, 26.24, 24.85, 24.68, 22.79, 14.62.

3i, 91% Yield.

¹H NMR (CDCl₃, 400 MHz): δ 8.09 (d, J=8.49 Hz, 2H), 7.68 (d, J=8.52 Hz, 2H), 5.23 (s, 1H), 3.47 (brs, 1H), 3.22-3.16 (m, 1H), 3.06-2.99 (m, 1H), 2.89-2.85 (m, 4H), 2.74-2.64 (m, 2H), 2.17-2.13 (m, 1H), 1.93-1.71 (m, 2H), 1.51-1.49 (m, 2H), 1.33-1.06 (m, 13H), 0.87 (t, J=6.83 Hz, 3H);

¹H NMR (CD₃OD, 400 MHz): δ 8.03 (d, J=8.23 Hz, 2H), 7.73 (d, J=8.23 Hz, 2H), 5.79 (brs, 1H), 5.10 (s, 1H), 3.12-3.07 (m, 1H), 2.96-2.80 (m, 5H), 2.68-2.56 (m, 2H), 1.87-1.68 (m, 3H), 1.49-1.40 (m, 3H), 1.32-1.12 (m, 12H), 0.83 (t, J=6.51 Hz, 3H);

¹³C NMR (CD₃OD, 100 MHz): δ 171.92, 162.36, 149.87, 130.39, 129.16, 123.90, 79.83, 76.93, 58.34, 36.29, 32.01, 30.20, 29.70, 29.67, 29.40, 26.65, 26.24, 24.85, 24.70, 22.82, 14.60.

General Procedure for Syntheses Amino Acid Based Compounds (4e, 4g and 4h):

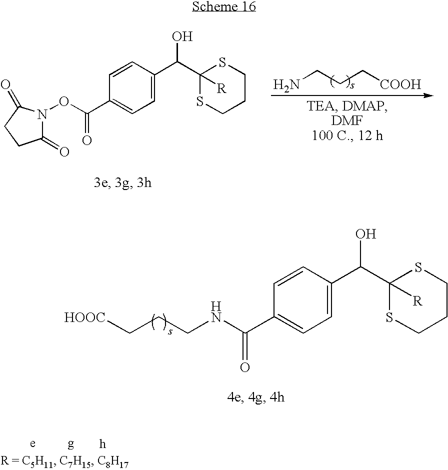

To a mixture 11-aminoundecanoic acid (101 mg, 0.5 mmol) and 1-({4-[2-alkyl-1,3-dithian-2-yl)(hydroxyl)methyl]benzoyl}oxy)pyrollidine-2,5-dione (0.45 mmol) in DMF (10 mL) was added triethylamine (2 mL) and a catalytic amount of DMAP. The resulting solution was stirred at 100° C. for 12 h. This solution was poured onto crushed ice and acidified with 5% HCl solution. This mixture was extracted with ethyl acetate (100 mL) and the organic layer was washed with water, dried over anhyd.Na₂SO₄ and the solvent was evaporated to get the crude solid. The product was purified by column chromatography with 40-60% ethyl acetate in hexane to give the desired compound.

4e, 82% Yield.

¹H NMR (CDCl₃, 400 MHz): δ 7.70 (d, J=8.41 Hz, 2H), 7.57 (d, J=8.43 Hz, 2H), 6.19 (brt, J=5.71 Hz, 1H), 5.19 (s, 1H), 3.46 (q, J1=6.68 Hz, J2=13.45 Hz, 2H), 3.22-3.15 (m, 1H), 3.05-2.99 (m, 1H), 2.73-2.65 (m, 2H), 2.34 (t, J=7.46 Hz, 2H), 2.15-2.12 (m, 1H), 1.89-1.72 (m, 2H), 1.63-1.45 (m, 6H), 1.28-1.10 (m, 18H), 0.85 (t, J=7.18 Hz, 3H);

¹H NMR (CD₃OD, 400 MHz): δ 7.75 (d, J=8.20 Hz, 2H), 7.62 (d, J=8.43 Hz, 2H), 5.14 (s, 1H), 3.37 (t, J=7.16 Hz, 2H), 3.13-3.06 (m, 1H), 2.96-2.89 (m, 1H), 2.68-2.58 (m, 2H), 2.28 (t, J=7.42 Hz, 2H), 2.00-1.94 (m, 1H), 1.87-1.77 (m, 2H), 1.62-1.50 (m, 6H), 1.39-1.24 (m, 17H), 0.88 (t, J=7.20 Hz, 3H);

¹³C NMR (CD₃OD, 100 MHz): δ 176.50, 168.88, 143.90, 133.77, 128.97, 125.77, 76.11, 57.92, 39.90, 36.00, 33.81, 32.27, 29.46, 29.39, 29.34, 29.28, 29.25, 29.08, 26.95, 26.43, 25.62, 24.94, 24.48, 23.96, 22.41, 13.28.

4g, 85% Yield.

¹H NMR (CDCl₃, 400 MHz): δ 7.71 (d, J=8.28 Hz, 2H), 7.58 (d, J=8.15 Hz, 2H), 6.13 (brt, J=5.73 Hz, 1H), 5.20 (s, 1H), 3.46 (q, J1=6.66 Hz, J2=13.21 Hz, 2H), 3.22-3.16 (m, 1H), 3.06-3.00 (m, 1H), 2.74-2.65 (m, 2H), 2.35 (t, J=7.47 Hz, 2H), 2.16-2.12 (m, 1H), 1.91-1.86 (m, 1H), 1.79-1.73 (m, 1H), 1.63-1.49 (m, 6H), 1.38-1.14 (m, 22H), 0.86 (t, J=6.88 Hz, 3H);

¹H NMR (CD₃OD, 400 MHz): δ 7.74 (d, J=8.31 Hz, 2H), 7.62 (d, J=8.44 Hz, 2H), 5.14 (s, 1H), 3.37 (t, J=7.17 Hz, 2H), 3.13-3.07 (m, 1H), 2.96-2.90 (m, 1H), 2.68-2.60 (m, 2H), 2.28 (t, J=7.42 Hz, 2H), 2.00-1.96 (m, 1H), 1.85-1.79 (m, 2H), 1.61-1.51 (m, 6H), 1.45-1.25 (m, 21H), 0.89 (t, J=6.85 Hz, 3H);

¹³C NMR (CD₃OD, 100 MHz): δ 176.50, 168.94, 143.93, 133.80, 128.96, 125.73, 76.17, 57.87, 39.86, 36.07, 33.77, 31.76, 29.94, 29.42, 29.34, 29.30, 29.21, 29.23, 29.07, 29.05, 26.90, 26.40, 25.61, 24.91, 24.46, 24.23, 22.50, 13.27.

4h, 80% Yield.

¹H NMR (CDCl₃, 400 MHz): δ 7.69 (d, J=8.27 Hz, 2H), 7.54 (d, J=8.34 Hz, 2H), 6.31 (brt, J=5.67 Hz, 1H), 5.17 (s, 1H), 3.43 (q, J1=6.93 Hz, J2=13.16 Hz, 2H), 3.19-3.12 (m, 1H), 3.03-2.96 (m, 1H), 2.71-2.62 (m, 2H), 2.33 (t, J=7.48 Hz, 2H), 2.12-2.09 (m, 1H), 1.87-1.83 (m, 1H), 1.76-1.71 (m, 2H), 1.61-1.44 (m, 6H), 1.39-1.13 (m, 23H), 0.86 (t, J=6.88 Hz, 3H);

¹H NMR (CD₃OD, 400 MHz): δ 7.74 (d, J=8.45 Hz, 2H), 7.62 (d, J=8.25 Hz, 2H), 5.14 (s, 1H), 3.37 (t, J=7.19 Hz, 2H), 3.14-3.07 (m, 1H), 2.97-2.90 (m, 1H), 2.67-2.59 (m, 2H), 2.28 (t, J=7.43 Hz, 2H), 1.99-1.96 (m, 1H), 1.85-1.79 (m, 2H), 1.61-1.52 (m, 6H), 1.44-1.25 (m, 23H), 0.90 (t, J=6.92 Hz, 3H);

¹³C NMR (CD₃OD, 100 MHz): δ 176.53, 168.91, 143.92, 133.79, 128.96, 125.76, 76.15, 57.90, 39.87, 36.05, 33.80, 31.83, 29.98, 29.44, 29.37, 29.36, 29.32, 29.25, 29.22, 29.18, 29.06, 26.92, 26.42, 25.61, 24.92, 24.47, 24.22, 22.55, 13.31.

Procedure for syntheses Sugar Based Compounds (6b, 6c and 6d):

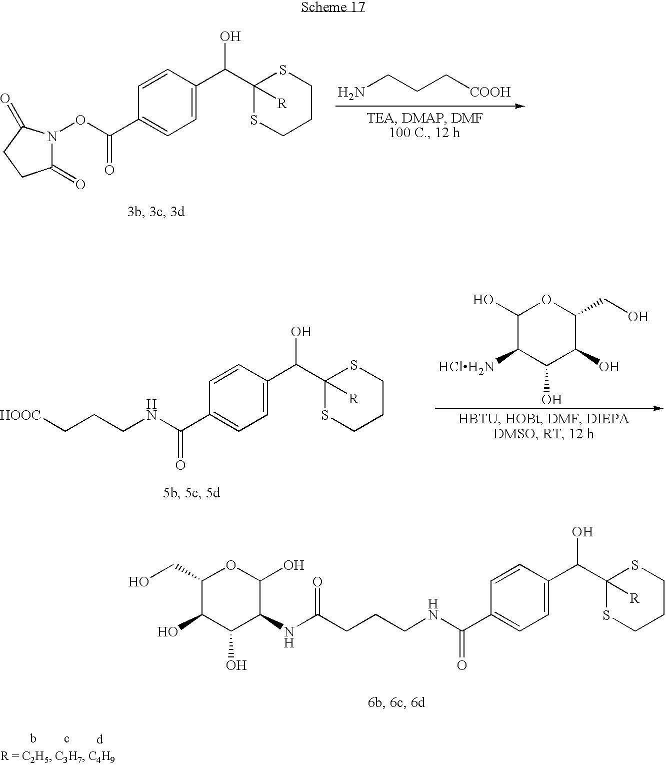

General Procedure for the Syntheses of 5b, 5c and 5d:

To a mixture of 4-aminobutyric acid (1.70 mmol) and 1-({4-[2-alkyl-1,3-dithian-2-yl)(hydroxyl)methyl]benzoyl}oxy)pyrollidine-2,5-dione (1.13 mmol) in DMF (15 mL) was added triethylamine (2 mL) and a catalytic amount of DMAP. The resulting solution was stirred at 100° C. for 12 h. This mixture was poured onto crushed ice and acidified with 5% HCl solution. This mixture was extracted with ethyl acetate (100 mL) and the organic layer was washed with water, dried over Na₂SO₄ and the solvent was evaporated to get the desired compound.

5b, 91% Yield.

¹H NMR (CDCl₃, 400 MHz): δ 7.70 (d, J=8.44 Hz, 2H), 7.55 (d, J=8.26 Hz, 2H), 6.80 (brt, J=5.71 Hz, 1H), 5.17 (s, 1H), 3.51 (q, J1=6.46 Hz, J2=12.60 Hz, 2H), 3.18-3.11 (m, 1H), 3.03-2.96 (m, 1H), 2.73-2.64 (m, 2H), 2.46 (t, J=6.85 Hz, 2H), 2.12-2.09 (m, 1H), 1.96-1.79 (m, 4H), 1.32-1.23 (m, 2H), 1.03 (t, J=7.43 Hz, 3H);

¹H NMR (CD₃OD, 400 MHz): δ 7.75 (d, J=8.40 Hz, 2H), 7.62 (d, J=8.27 Hz, 2H), 5.12 (s, 1H), 3.43 (t, J=6.94 Hz, 2H), 3.06-3.02 (m, 1H), 2.90-2.85 (m, 1H), 2.69-2.60 (m, 2H), 2.40 (t, J=7.35 Hz, 2H), 1.95-1.87 (m, 4H), 1.79-1.75 (m, 1H), 1.54-1.49 (m, 1H), 1.05 (t, J=7.40 Hz, 3H);

¹³C NMR (CD₃OD, 100 MHz): δ 175.88, 169.04, 143.98, 133.58, 129.03, 125.81, 76.08, 58.55, 39.29, 31.26, 28.70, 26.26, 25.45, 24.70, 24.42, 8.37.

5c, 95% Yield.

¹H NMR (CDCl₃, 400 MHz): δ 7.70 (d, J=8.14 Hz, 2H), 7.49 (d, J=8.16 Hz, 2H), 7.15 (brt, J=5.25 Hz, 1H), 5.11 (s, 1H), 3.40 (q, J1=5.95 Hz, J2=12.04 Hz, 2H), 3.13-3.06 (m, 1H), 2.96-2.90 (m, 1H), 2.66-2.53 (m, 2H), 2.38 (t, J=6.79 Hz, 2H), 2.10-1.97 (m, 1H), 1.86-1.67 (m, 4H), 1.54-1.39 (m, 2H), 1.22-1.13 (m, 2H), 0.85 (t, J=7.23 Hz, 3H);

¹H NMR (CD₃OD, 400 MHz): δ 7.75 (d, J=8.39 Hz, 2H), 7.62 (d, J=8.28 Hz, 2H), 5.13 (s, 1H), 3.43 (t, J=6.94 Hz, 2H), 3.12-3.05 (m, 1H), 2.95-2.89 (m, 1H), 2.67-2.59 (m, 2H), 2.40 (t, J=7.35 Hz, 2H), 2.00-1.76 (m, 5H), 1.62-1.53 (m, 2H), 1.42-1.34 (m, 1H), 1.27 (t, J=7.31 Hz, 3H);

¹³C NMR (CD₃OD, 100 MHz): δ 175.89, 169.07, 143.97, 133.62, 129.01, 125.82, 76.08, 57.90, 39.28, 38.27, 31.26, 26.41, 25.60, 24.70, 24.45, 17.67, 13.70.

5d, 97% Yield.

¹H NMR (CDCl₃, 400 MHz): δ 7.76 (d, J=8.20 Hz, 2H), 7.55 (d, J=8.26 Hz, 2H), 7.10 (brt, J=5.42 Hz, 1H), 5.12 (s, 1H), 3.42 (q, J1=5.90 Hz, J2=12.50 Hz, 2H), 3.13-3.04 (m, 1H), 2.97-2.91 (m, 1H), 2.67-2.56 (m, 2H), 2.39 (t, J=6.76 Hz, 2H), 2.07-1.98 (m, 1H), 1.86-1.66 (m, 4H), 1.54-1.38 (m, 2H), 1.28-1.08 (m, 4H), 0.82 (t, J=7.21 Hz, 3H);

¹H NMR (CD₃OD, 400 MHz): δ 7.75 (d, J=8.41 Hz, 2H), 7.62 (d, J=8.35 Hz, 2H), 5.14 (s, 1H), 3.43 (t, J=6.96 Hz, 2H), 3.12-3.05 (m, 1H), 2.96-2.89 (m, 1H), 2.68-2.58 (m, 2H), 2.40 (t, J=7.36 Hz, 2H), 1.98-1.75 (m, 5H), 1.61-1.48 (m, 2H), 1.45-1.37 (m, 1H), 1.27-1.18 (m, 2H), 0.88 (t, J=7.34 Hz, 3H);

¹³C NMR (CD₃OD, 100 MHz): δ 175.87, 169.04, 143.96, 133.60, 129.02, 125.82, 76.05, 57.91, 39.29, 35.74, 31.26, 26.53, 26.44, 25.62, 24.70, 24.48, 23.10, 13.29.

General Procedure for the Syntheses of 6b, 6c and 6d:

To a mixture of 5a (190 mg, 0.49 mmol), HBTU (206 mg, 0.54 mmol), and HOBt (73 mg, 0.54 mmol) in DMF (10 mL) was added DIPEA (0.2 mL, 1.08 mmol). The reaction mixture was then stirred for 5 min at ambient temperature. D-glucosamine hydrochloride (117 mg, 0.54 mmol) was dissolved in 1 mL DMSO, added to the above solution and stirred at room temperature for 12 h. The reaction mixture was poured into cold ether and allowed to settle down. The ether layer was decanted off and the brownish yellow material was washed with cold ether several times before drying. The product was purified by column chromatography using an eluent of 5% methanol in methylene chloride to give the desired compound.

6b, 65% Yield.

¹H NMR (CD₃OD, 400 MHz): δ 7.77 (d, J=8.46 Hz, 2H), 7.64 (d, J=8.36 Hz, 2H), 5.12 (s, 1H), 5.10 (d, J=3.45 Hz, α-anomer), 4.61 (d, J=8.4 Hz, β-anomer), 3.89-3.65 (m, 5H), 3.47-3.32 (m, 3H), 3.11-3.04 (m, 1H), 2.94-2.87 (m, 1H), 2.71-2.61 (m, 2H), 2.36-2.32 (m, 2H), 2.00-1.87 (m, 4H), 1.83-1.74 (m, 1H), 1.58-1.49 (m, 1H), 1.39-1.27 (m, 1H), 1.06 (t, J=7.41 Hz, 3H);

¹³C NMR (CD₃OD, 100 MHz): δ 174.85, 169.00, 144.09, 133.42, 129.03, 125.87, 91.42, 76.07, 71.92, 71.53, 71.26, 61.59, 58.53, 54.67, 39.18, 33.06, 28.68, 26.25, 25.56, 25.45, 24.42, 8.35.

6c, 62% Yield.

¹H NMR (CD₃OD, 400 MHz): δ 7.78 (d, J=8.40 Hz, 2H), 7.63 (d, J=8.32 Hz, 2H), 5.14 (s, 1H), 5.11 (d, J=3.40 Hz, α-anomer), 4.62 (d, J=8.36 Hz, β-anomer), 3.86-3.63 (m, 5H), 3.48-3.32 (m, 3H), 3.14-3.07 (m, 1H), 2.97-2.90 (m, 1H), 2.70-2.60 (m, 2H), 2.37-2.33 (m, 2H), 2.00-1.88 (m, 3H), 1.85-1.78 (m, 2H), 1.64-1.51 (m, 2H), 1.38-1.32 (m, 2H), 0.86 (t, J=7.32 Hz, 3H);

¹³C NMR (CD₃OD, 100 MHz): δ 169.06, 144.08, 133.50, 128.98, 125.83, 125.81, 91.40, 76.12, 71.91, 71.50, 71.28, 61.60, 57.83, 54.68, 39.11, 38.30, 33.03, 28.69, 26.38, 25.57, 24.45, 17.62, 13.62.

6d, 56% Yield.

¹H NMR (CD₃OD, 400 MHz): δ 7.77 (d, J=8.45 Hz, 2H), 7.63 (d, J=8.30 Hz, 2H), 5.14 (s, 1H), 5.11 (d, J=3.41 Hz, α-anomer), 4.61 (d, J=8.31 Hz, β-anomer), 3.84-3.61 (m, 5H), 3.45-3.35 (m, 3H), 3.14-3.05 (m, 1H), 2.97-2.90 (m, 1H), 2.69-2.58 (m, 2H), 2.36-2.32 (m, 2H), 2.00-1.88 (m, 5H), 1.59-1.48 (m, 2H), 1.38-1.34 (m, 2H), 1.29-1.18 (m, 2H), 0.89 (t, J=7.33 Hz, 3H);

¹³C NMR (CD₃OD, 100 MHz): δ 174.74, 169.04, 144.04, 133.57, 128.98, 125.79, 91.40, 76.13, 71.92, 71.46, 71.31, 61.63, 57.83, 54.71, 51.51, 39.12, 35.78, 33.13, 26.49, 26.39, 25.59, 24.46, 23.06, 17.58, 13.18.

Procedure for Syntheses of Biotin Based Compounds (10a, 10f and 10i)

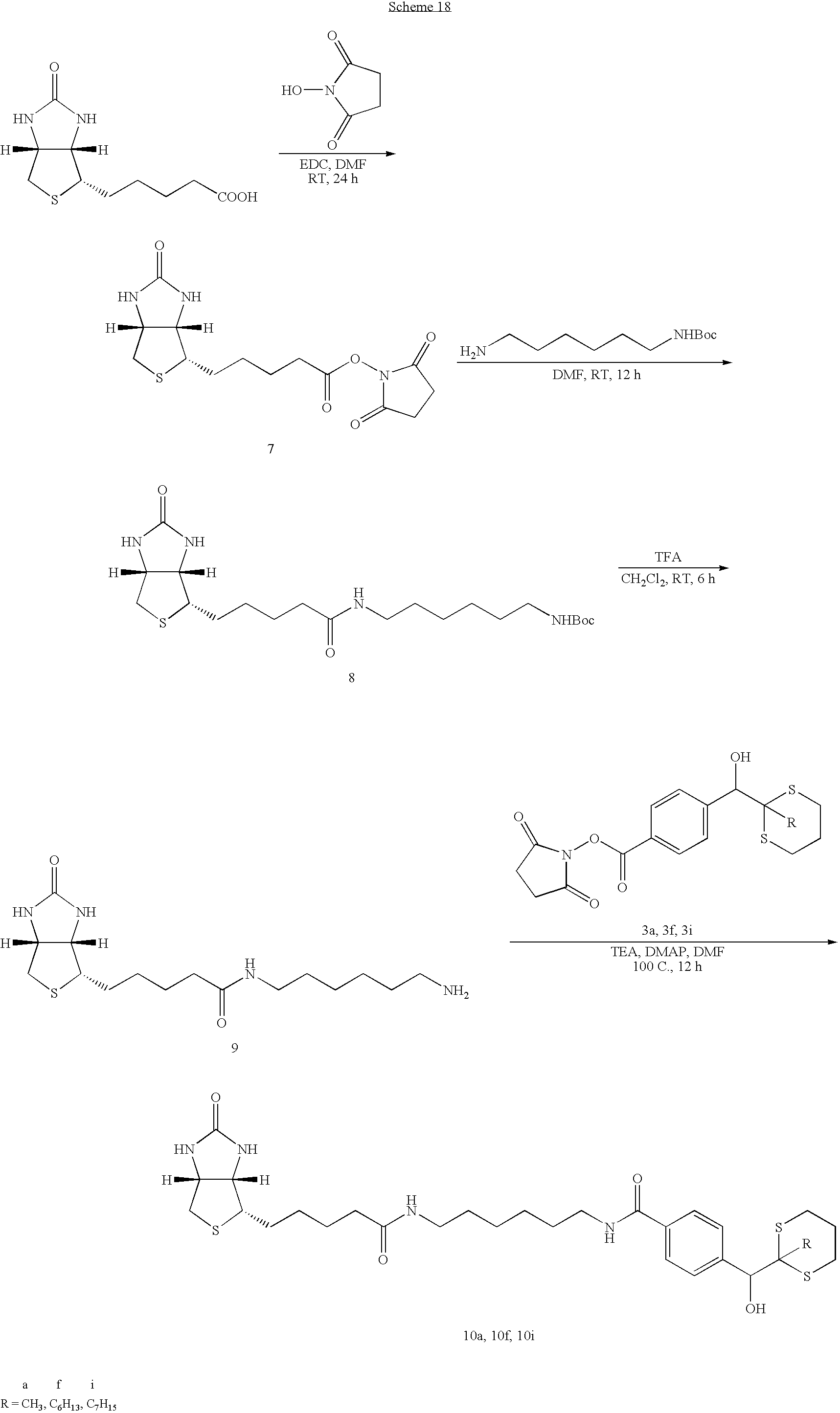

Preparation of 7:

A mixture of biotin (1.0 g, 4.09 mmol), N-hydroxysuccinimide (753 mg, 6.54 mmol), and EDC (1.02 g, 5.32 mmol) was dissolved in DMF (40 mL) and stirred for 24 h at ambient temperature. The solution was poured onto crushed ice and the solid obtained was filtered, washed with water and, dried to give 7.

7, 95% Yield.

¹H NMR (DMSO-d₆, 400 MHz): δ 6.40 (brs, 1H), 6.34 (brs, 1H), 4.30-4.26 (m, 1H), 4.16-4.12 (m, 1H), 2.84-2.76 (m, 6H), 2.67-2.62 (m, 2H), 2.58 (d, 1H), 1.66-1.57 (m, 3H), 1.52-1.36 (m, 3H),

¹³C NMR (DMSO-d₆, 100 MHz): δ 170.95, 169.61, 163.35, 61.66, 59.83, 55.91, 30.66, 28.50, 28.25, 26.12, 24.98

Preparation of 8:

A mixture of 7 (500 mg, 1.46 mmol) and N-boc-1,6-diaminohexane (411 mg, 1.90 mmole) in DMF (20 mL) was stirred for 12 h at ambient temperature. The reaction mixture was poured onto crushed ice, the solid was collected by vacuum filtration, washed with water and dried to give pure 8.

8, 96% Yield.

¹H NMR (DMSO-d₆, 400 MHz): δ 7.71 (brt, J=5.36 Hz, 1H), 6.73 (brt, J=5.56 Hz, 1H), 6.39 (s, 1H), 6.33 (s, 1H), 4.29-4.26 (m, 1H), 4.11-4.09 (m, 1H), 3.09-3.04 (m, 1H), 3.01 (q, J₁=6.65 Hz, J2=13.06 Hz, 2H), 2.88-2.77 (m, 3H), 2.57 (d, J=12.32 Hz, 1H), 2.03 (t, J=7.41 Hz, 2H), 1.62-1.20 (m, 23H);

¹H NMR (CD₃OD, 400 MHz): δ 4.50-4.47 (m, 1H), 4.31-4.28 (m, 1H), 3.21-3.13 (m, 3H), 3.03 (t, J=6.98 Hz, 2H), 2.94 (dd, J1=4.96 Hz, J2=12.74 Hz, 1H), 2.71 (d, 12.74 Hz, 1H), 2.20 (t, J=7.39 Hz, 2H), 1.75-1.54 (m, 4H), 1.49-1.42 (m, 15H), 1.34-1.32 (m, 4H);

¹³C NMR (CD₃OD, 100 MHz): δ 174.75, 164.91, 157.37, 78.59, 62.20, 60.43, 55.84, 40.05, 39.87, 39.09, 35.64, 29.72, 29.18, 28.61, 28.33, 27.63, 26.47, 26.33, 25.77.

Preparation of 9:

8 (500 mg, 1.45 mmol) was dissolved in a mixture of CH₂Cl₂ (5 mL) and CF₃COOH (2 mL) to be stirred at room temperature for 6 h. The solvents were evaporated to dryness to give pure 9.

9, 95% Yield.

¹H NM R (DMSO-d₆, 400 MHz): δ 7.75 (t, J=5.58 Hz, 1H), 7.63 (brs, 2H), 6.41 (brs, 2H), 4.30-4.27 (m, 1H), 4.12-4.09 (m, 1H), 3.09-3.04 (m, 1H), 3.02 (q, J1=6.65 Hz, J2=12.92 Hz, 2H), 2.82-2.71 (m, 3H), 2.57 (d, J=12.57 Hz, 1H), 2.04 (t, J=7.29 Hz, 2H), 1.63-1.22 (m, 14H);

¹³C NMR (DMSO-d₆, 100 MHz): δ 172.51, 163.41, 61.73, 59.87, 56.13, 39.45, 38.88, 35.88, 29.68, 28.91, 28.73, 27.64, 26.57, 26.16, 26.04.

General Procedure for the Syntheses of 10a, 10f and 10i:

To a mixture of 9 (100 mg, 0.29 mmol) and 1-({4-[2-alkyl-1,3-dithian-2-yl) (hydroxyl)methyl]benzoyl}oxy)pyrollidine-2,5-dione (0.22 mmol) in DMF (10 mL) was added triethylamine (1 mL) and a catalytic amount of DMAP. The resulting solution was stirred at 100° C. for 12 h. The solvent was removed under vacuo and the residue was dissolved in ethyl acetate (100 mL). The organic layer was washed with water, dried over Na₂SO₄ and the solvent was evaporated to obtain a brownish solid. The crude product was purified by column chromatography using 10% methanol in ethyl acetate as eluent to give the desired compound.

10a, 86% Yield.

¹H NMR (CD₃OD, 400 MHz): δ 7.75 (d, J=8.34 Hz, 2H), 7.58 (d, J=8.45 Hz, 2H), 5.10 (s, 1H), 4.47-4.44 (m, 1H), 4.28-4.25 (m, 1H), 3.38 (t, J=7.11 Hz, 2H), 3.21-2.98 (m, 6H), 2.92-2.85 (m, 2H), 2.72-2.66 (m, 3H), 2.20 (t, J=7.37 Hz, 2H), 2.04-2.02 (m, 1H), 1.87-1.84 (m, 1H), 1.72-1.33 (m, 12H), 1.28 (s, 3H);

¹³C NMR (CD₃OD, 100 MHz): 6174.77, 168.88, 164.62, 143.71, 133.83, 128.72, 125.81, 76.56, 62.19, 60.42, 55.84, 52.82, 39.87, 39.69, 39.04, 35.65, 29.27, 29.16, 28.60, 28.33, 26.54, 26.51, 26.45, 26.00, 25.78, 24.62, 22.56.

10f, 82% Yield.

¹H NMR (CD₃OD, 400 MHz): δ 7.75 (d, J=8.27 Hz, 2H), 7.62 (d, J=8.30 Hz, 2H), 5.14 (s, 1H), 4.47-4.44 (m, 1H), 4.29-4.26 (m, 1H), 3.38 (t, J=7.08 Hz, 2H), 3.20-3.08 (m, 4H), 2.94-2.87 (m, 2H), 2.69-2.61 (m, 3H), 2.20 (t, J=7.27 Hz, 2H), 1.98-1.25 (m, 26H), 0.89 (t, J=6.90 Hz, 3H);

¹³C NMR (CD₃OD, 100 MHz): δ 174.78, 168.94, 164.90, 143.97, 133.77, 128.97, 125.73, 76.16, 75.10, 62.19, 60.41, 57.85, 55.83, 39.85, 39.68, 39.03, 35.63, 36.05, 31.65, 29.66, 29.25, 29.15, 28.59, 28.32, 26.51, 26.44, 26.39, 25.76, 25.59, 24.47, 24.20, 22.45, 13.21.

10i, 76% Yield.

¹H NMR (CD₃OD, 400 MHz): δ 7.75 (d, J=8.18 Hz, 2H), 7.62 (d, J=8.21 Hz, 2H), 5.14 (s, 1H), 4.47-4.44 (m, 1H), 4.29-4.26 (m, 1H), 3.38 (t, J=6.98 Hz, 2H), 3.18-3.08 (m, 4H), 2.98-2.87 (m, 2H), 2.69-2.61 (m, 3H), 2.20 (t, J=7.26 Hz, 2H), 1.97-1.26 (m, 32H), 0.90 (t, J=6.76 Hz, 3H);

¹³C NMR (CD₃OD, 100 MHz): δ 174.75, 168.88, 164.88, 143.95, 133.75, 128.98, 125.76, 76.12, 62.19, 60.42, 57.92, 55.85, 39.89, 39.71, 39.06, 36.02, 35.66, 31.88, 29.98, 29.46, 29.40, 29.28, 29.25, 29.17, 28.62, 28.34, 26.54, 26.47, 26.42, 25.79, 25.62, 24.48, 24.23, 22.57, 13.33.

Procedure for Synthesis of ET-Sensitizer (13):

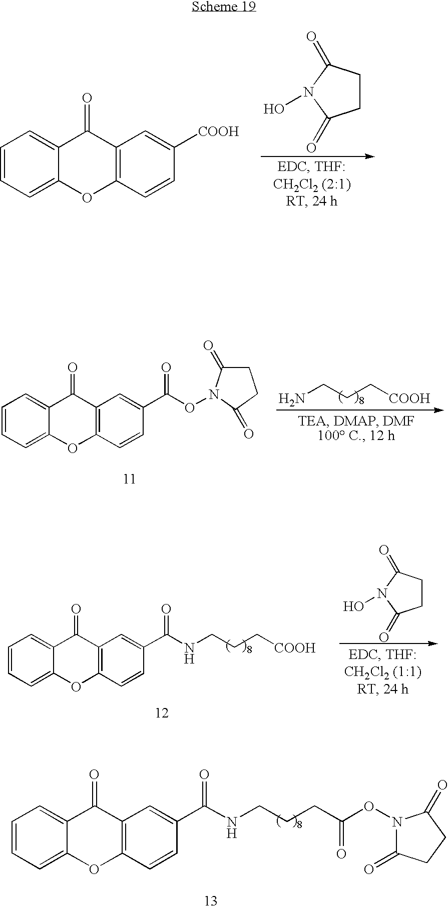

Preparation of 11:

A mixture of 9-oxo-9H-xanthene-2-carboxylic acid (300 mg, 1.25 mmol), N-hydroxysuccinimide (230 mg, 2 mmol) and EDC (287 mg, 1.55 mmol) was dissolved in THF:CH₂Cl₂ (2:1, 30 mL) and stirred for 24 h at room temperature. The solution was washed with 20 mL water and 20 mL of saturated NaHCO₃ followed by 10 mL of brine. The organic layer was dried over anhydrous Na₂SO₄ and the solvent was evaporated in vacuum to give the desired compound.

11, 96% Yield.

¹H NMR (CDCl₃, 400 MHz): δ 9.17 (d, J=2.05 Hz, 1H), 8.43 (dd, J₁=2.25 Hz, J2=8.84 Hz, 1H), 8.36 (dd, J1=1.70 Hz, J2=8.18 Hz, 1H), 7.81-7.77 (m, 1H), 7.63 (d, J=8.82 Hz, 1H), 7.56 (d, J=7.84 Hz, 1H), 7.47-7.43 (m, 1H), 2.93 (s, 4H);

¹³C NMR (CDCl₃, 100 MHz): δ 173.02, 169.46, 160.96, 159.78, 155.94, 135.92, 135.88, 131.02, 126.98, 125.17, 121.79, 121.75, 121.00, 119.39, 118.36, 25.94.

Preparation of 12:

To a mixture 11-aminoundecanoic acid (71 mg, 0.35 mmol) and 1-{[(9-oxo-9H-xanthen-2-yl)carbonyl]oxy}pyrrolidine-2,5-dione (11, 100 mg, 0.29 mmol) in DMF (10 mL) was added triethylamine (2 mL) and a catalytic amount of DMAP. The resulting solution was stirred at 100° C. for 12 h, then poured onto crushed ice and acidified with 5% HCl solution, the solid was obtained by vacuum filtration, washed with water and dried. The crude product was purified by crystallization from methanol.

12, 75% Yield.

¹H NMR (DMSO-d₆, 400 MHz): δ 8.77 (brt, J=5.43 Hz, 1H), 8.69 (d, J=2.20 Hz, 1H), 8.30 (dd, J1=2.27 Hz, J2=8.80 Hz, 1H), 8.21 (dd, J1=1.56 Hz, J2=7.93 Hz, 1H), 7.91-7.87 (m, 1H), 7.74 (dd, J1=8.59 Hz, J2=18.43 Hz, 2H), 7.51-7.48 (m, 1H), 3.27 (q, J1=6.72 Hz, J2=12.81 Hz, 2H), 2.16 (t, J=7.36 Hz, 2H), 1.52-1.44 (m, 4H), 1.24-1.16 (m, 12H);

¹³C NMR (DMSO-d₆, 100 MHz): δ 176.56, 175.14, 165.18, 157.65, 156.15, 136.43, 134.81, 131.13, 126.71, 125.88, 125.34, 121.75, 121.23, 119.01, 118.90, 34.32, 29.70, 29.66, 29.58, 29.47, 29.44, 29.24, 27.21, 25.17.

Preparation of 13:

A mixture of 12 (200 mg, 1.22 mmol), N-hydroxysuccinimide (87 mg, 0.75 mmol) and EDC (113 mg, 0.59 mmol) was dissolved in THF:CH₂Cl₂ (1:1, 20 mL) and stirred for 24 h at room temperature. The solution was washed with 20 mL of water, 20 mL of saturated NaHCO₃, and 10 mL of brine. The solution was dried over anhydrous Na₂SO₄ and evaporated in vacuum to give the crude product which was purified by column chromatography using 60% ethyl acetate-hexane as eluent to give the pure compound.

13, 85% Yield.

¹H NMR (DMSO-d₆, 400 MHz): δ 8.77 (brt, J=5.42 Hz, 1H), 8.69 (d, J=2.21 Hz, 1H), 8.30 (dd, J1=2.27 Hz, J2=8.79 Hz, 1H), 8.21 (dd, J1=1.60 Hz, J2=7.93 Hz, 1H), 7.91-7.87 (m, 1H), 7.73 (dd, J1=8.63 Hz, J2=17.64 Hz, 2H), 7.51-7.47 (m, 1H), 3.28 (q, J1=5.86 Hz, J2=11.94 Hz, 2H), 2.78 (s, 4H), 2.63 (t, J=7.20 Hz, 2H), 1.59-1.51 (m, 4H), 1.38-1.24 (m, 12H);

¹³C NMR (DMSO-d₆, 100 MHz): δ 176.63, 170.91, 169.64, 165.22, 157.70, 156.21, 144.93, 136.52, 134.85, 131.17, 126.75, 125.89, 125.42, 121.79, 121.28, 119.09, 118.97, 30.86, 29.69, 29.57, 29.48, 29.43, 29.18, 28.68, 27.19, 26.11, 24.97.

General Procedure for Syntheses of 14(a-i)

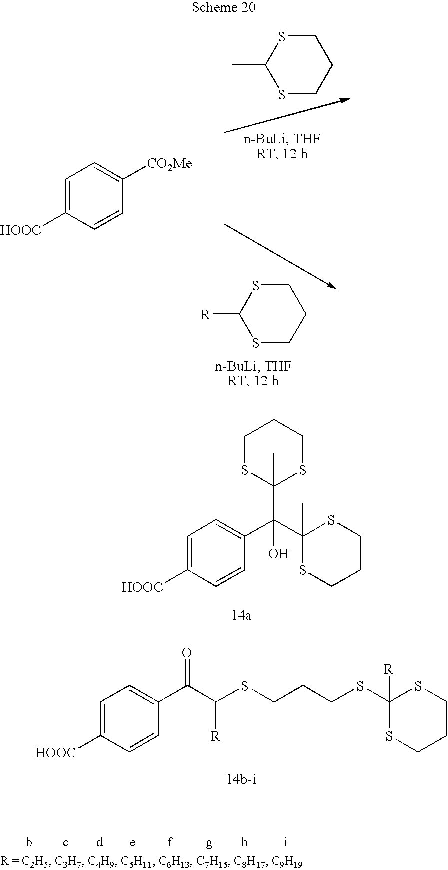

n-BuLi (8.96 mL, 14.3 mmol, 1.6 M solution in THF) was added at 20° C. to a mixture of 2-alkyl-1,3-dithiane (14-17 mmol) in 50 mL of dry THF. The resulting solution was stirred at this temperature for 15 min. Monomethylterephthalate (516 mg, 2.86 mmol) in THF (30 mL) was added to the generated dithiane anion and the solution was stirred overnight. Aqueous work-up included quenching with saturated NH₄Cl (20 mL) followed by extraction with ethyl acetate (3×50 mL). The organic layer was dried over Na₂SO₄ and the solvent was removed in vacuum. The crude product was purified by chromatography on a slurry-packed silica gel column using 10% EtOAc-hexane as eluent.

14a, 85% Yield.

¹H NMR (DMSO-d₆, 400 MHz): δ 8.52 (d, J=8.58 Hz, 1H), 7.80 (s, 2H), 7.74 (d, J=8.49 Hz, 1H), 5.29 (brs, 1H), 2.84-2.77 (m, 2H), 2.68-2.63 (m, 2H), 2.59-2.53 (m, 2H), 2.26-2.20 (m, 2H), 2.04 (s, 6H), 1.79-1.72 (m, 2H), 1.59-1.49 (m, 2H);

¹³C NMR (DMSO-d₆, 100 MHz): δ 168.10, 146.65, 131.26, 130.62, 129.92, 127.47, 126.46, 86.95, 63.29, 28.85, 27.97, 26.48, 24.51.

14b, 82% Yield.

¹H NMR (CDCl₃, 400 MHz): δ 8.21 (d, J=8.58 Hz, 2H), 8.62 (d, J=8.62 Hz, 2H), 4.05 (t, J=7.30 Hz, 1H), 3.28-3.20 (m, 2H), 2.63-2.57 (m, 3H), 2.51-2.44 (m, 3H), 2.13-2.05 (m, 2H), 1.99-1.90 (m, 3H), 1.82-1.73 (m, 3H), 1.11 (t, J=7.38 Hz, 3H), 1.06 (t, J=7.33 Hz, 3H);

¹³C NMR (CDCl₃, 100 MHz): δ 194.85, 170.59, 140.58, 132.97, 130.66, 128.74, 63.58, 49.35, 36.07, 31.87, 28.89, 28.19, 27.53, 25.29, 23.34, 14.60, 12.24, 9.07.

14c, 83% Yield.

¹H NMR (CDCl₃, 400 MHz): δ 8.21 (d, J=8.70 Hz, 2H), 8.08 (d, J=8.75 Hz, 2H), 4.12 (t, J=7.38 Hz, 1H), 3.28-3.20 (m, 2H), 2.64-2.42 (m, 6H), 2.10-2.01 (m, 2H), 1.91-1.73 (m, 6H), 1.66-1.59 (m, 2H), 1.54-1.38 (m, 2H), 0.97 (t, J=7.36 Hz, 3H), 0.92 (t, J=7.34 Hz, 3H);

¹³C NMR (CDCl₃, 100 MHz): 6194.76, 171.42, 140.49, 132.98, 130.62, 128.72, 62.77, 47.19, 45.34, 32.12, 31.96, 28.90, 28.23, 27.58, 27.56, 25.27, 20.84, 17.81, 14.30, 14.17.

14d, 86% Yield.

¹H NMR (CDCl₃, 400 MHz): δ 8.20 (d, J=8.68 Hz, 2H), 8.08 (d, J=8.75 Hz, 2H), 4.12 (t, J=7.38 Hz, 1H), 3.29-3.21 (m, 2H), 2.64-2.42 (m, 6H), 2.12-2.04 (m, 2H), 1.94-1.90 (m, 2H), 1.85-1.75 (m, 4H), 1.63-1.55 (m, 2H), 1.40-1.29 (m, 6H), 0.93-0.89 (m, 6H);

¹³C NMR (CDCl₃, 100 MHz): 6194.83, 171.45, 140.48, 133.17, 130.63, 128.72, 62.82, 47.47, 42.91, 31.97, 29.86, 29.82, 28.87, 28.25, 27.58, 26.47, 25.29, 22.92, 22.76, 14.21, 14.20, 14.15.

14e, 85% Yield.

¹H NMR (CDCl₃, 400 MHz): δ 8.21 (d, J=8.67 Hz, 2H), 8.08 (d, J=8.70 Hz, 2H), 4.12 (t, J=7.33 Hz, 1H), 3.29-3.20 (m, 2H), 2.60-2.42 (m, 6H), 2.10-2.04 (m, 2H), 1.93-1.75 (m, 6H), 1.64-1.57 (m, 2H), 1.38-1.21 (m, 10H), 0.90 (t, J=7.07 Hz, 6H);

¹³C NMR (CDCl₃, 100 MHz): 6194.83, 171.57, 140.57, 133.00, 130.66, 128.73, 62.87, 47.52, 43.15, 31.98, 31.95, 31.81, 30.11, 28.90, 28.27, 27.60, 27.59, 27.35, 25.29, 24.02, 22.72, 22.69, 14.26, 14.25.

14f, 81% Yield.

¹H NMR (CDCl₃, 400 MHz): δ 8.20 (d, J=8.66 Hz, 2H), 8.08 (d, J=8.72 Hz, 2H), 4.12 (t, J=7.33 Hz, 1H), 3.29-3.20 (m, 2H), 2.64-2.49 (m, 6H), 2.09-2.05 (m, 2H), 1.94-1.80 (m, 6H), 1.64-1.57 (m, 2H), 1.38-1.25 (m, 14H), 0.89 (t, J=6.81 Hz, 6H);

¹³C NMR (CDCl₃, 100 MHz): δ 194.84, 171.10, 140.58, 132.95, 130.66, 128.73, 62.87, 47.54, 43.20, 31.98, 31.86, 31.80, 30.18, 29.45, 29.31, 28.90, 28.28, 27.64, 27.60, 25.29, 24.29, 22.79, 22.72, 14.29, 14.22.

14g, 88% Yield.

¹H NMR (CDCl₃, 400 MHz): δ 8.21 (d, J=8.27 Hz, 2H), 8.09 (d, J=8.40 Hz, 2H), 4.12 (t, J=7.33 Hz, 1H), 3.29-3.21 (m, 2H), 2.66-2.42 (m, 6H), 2.11-2.03 (m, 2H), 1.94-1.74 (m, 6H), 1.64-1.56 (m, 2H), 1.48-1.27 (m, 18H), 0.89 (t, J=6.79 Hz, 6H);

¹³C NMR (CDCl₃, 100 MHz): δ 194.83, 171.56, 140.59, 132.97, 130.65, 128.73, 62.87, 47.53, 43.19, 33.21, 31.99, 31.97, 30.16, 29.75, 29.61, 29.59, 29.35, 29.31, 28.89, 28.27, 27.68, 27.59, 25.29, 24.34, 23.65, 22.87, 22.85, 14.33.

14h, 87% Yield.

¹H NMR (CDCl₃, 400 MHz): δ 8.21 (d, J=8.16 Hz, 2H), 8.08 (d, J=8.28 Hz, 2H), 4.12 (t, J=7.34 Hz, 1H), 3.28-3.20 (m, 2H), 2.62-2.44 (m, 6H), 2.10-2.02 (m, 2H), 1.93-1.73 (m, 6H), 1.64-1.54 (m, 2H), 1.39-1.17 (m, 22H), 0.88 (t, J=6.77 Hz, 6H);

¹³C NMR (CDCl₃, 100 MHz): δ 194.81, 171.35, 140.52, 133.06, 130.61, 128.71, 62.87, 47.53, 43.18, 32.07, 32.05, 31.96, 31.80, 30.16, 29.79, 29.65, 29.63, 29.59, 29.45, 29.43, 28.90, 28.26, 27.66, 27.59, 25.29, 24.32, 22.87, 14.36.

14i, 82% Yield.

¹H NMR (CDCl₃, 400 MHz): δ 8.20 (d, J=8.21 Hz, 2H), 8.08 (d, J=8.29 Hz, 2H), 4.12 (t, J=7.27 Hz, 1H), 3.29-3.21 (m, 2H), 2.64-2.42 (m, 6H), 2.12-2.03 (m, 2H), 1.93-1.78 (m, 6H), 1.64-1.57 (m, 2H), 1.37-1.22 (m, 26H), 0.89 (t, J=6.84 Hz, 6H);

¹³C NMR (CDCl₃, 100 MHz): δ 194.84, 171.49, 140.61, 132.95, 130.66, 128.73, 62.88, 47.57, 43.21, 32.11, 32.09, 31.98, 30.19, 29.80, 29.76, 29.73, 29.68, 29.65, 29.53, 29.51, 28.91, 28.30, 27.68, 27.60, 25.30, 24.34, 22.91, 22.90, 14.35, 14.34.

General Procedure for Syntheses of 15(a-i)

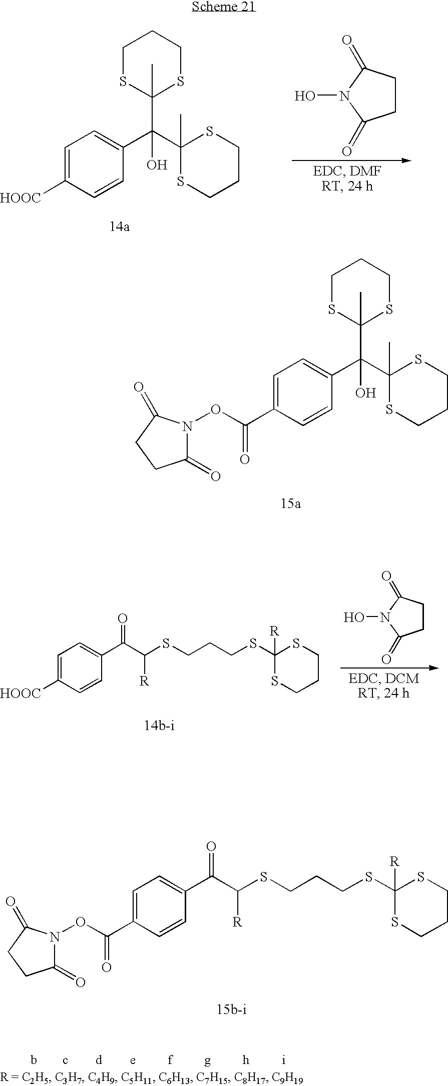

Preparation of 15a:

A mixture of 14a (900 mg, 2.16 mmol), N-hydroxysuccinimide (398 mg, 3.46 mmol) and EDC (539 mg, 2.81 mmol) was dissolved in DMF (30 mL) and stirred for 24 h at room temperature. The solution was poured into crushed ice and the solid was obtained by vacuum filtration, washed with water and dried to give pure 15a.

15a, 96% Yield.

¹H NMR (CDCl₃, 400 MHz): δ 8.36 (dd, J1=1.90 Hz, J₂=8.53 Hz, 1H), 8.12 (dq, J₁=1.94 Hz, J₂=8.44 Hz, 2H), 8.04 (dd, J₁=1.94 Hz, J₂=8.52 Hz, 1H), 4.50 (s, 1H), 2.90-2.80 (m, 8H), 2.75-2.70 (m, 4H), 2.16 (s, 6H), 1.96-1.78 (m, 4H);

¹³C NMR (CDCl₃, 100 MHz): δ 169.53, 161.92, 147.43, 130.52, 130.08, 129.46, 127.94, 124.45, 86.41, 63.41, 28.75, 27.94, 27.77, 25.92, 24.02.

Preparation of 15 (b-i):

A mixture 14b (2.95 mmol), N-hydroxysuccinimide (4.72 mmol) and EDC (3.83 mmol) was dissolved in CH₂Cl₂ (30 mL) and stirred for 24 h at room temperature. The solution was washed with 20 mL water, 20 mL of saturated NaHCO₃, followed by 10 mL of brine. Then the solution was dried over anhydrous Na₂SO₄ and the solvent was evaporated in vacuum to give the desired compound.

15b, 92% Yield.

¹H NMR (CDCl₃, 400 MHz): δ 8.23 (d, J=8.74 Hz, 2H), 8.11 (d, J=8.44 Hz, 2H), 4.02 (t, J=7.36 Hz, 1H), 3.27-3.19 (m, 2H), 2.92 (brs, 4H), 2.62-2.38 (m, 6H), 2.12-2.05 (m, 2H), 2.00-1.74 (m, 6H), 1.12 (t, J=7.38 Hz, 3H), 1.06 (t, J=7.33 Hz, 3H);

15c, 94% Yield.

¹H NMR (CDCl₃, 400 MHz): δ 8.23 (d, J=8.75 Hz, 2H), 8.11 (d, J=8.77 Hz, 2H), 4.11 (t, J=7.38 Hz, 1H), 3.28-3.20 (m, 2H), 2.92 (brs, 4H), 2.63-2.40 (m, 6H), 2.11-2.00 (m, 2H), 1.92-1.73 (m, 6H), 1.68-1.58 (m, 2H), 1.54-1.38 (m, 2H), 0.98 (t, J=7.36 Hz, 3H), 0.93 (t, J=7.35 Hz, 3H);

¹³C NMR (CDCl₃, 100 MHz): δ 194.33, 169.37, 161.35, 141.31, 130.93, 128.95, 128.69, 62.76, 47.29, 45.34, 31.98, 31.95, 28.87, 28.20, 27.55, 25.92, 25.23, 20.77, 17.80, 14.28, 14.12.

15d, 93% Yield.

¹H NMR (CDCl₃, 400 MHz): δ 8.22 (d, J=8.74 Hz, 2H), 8.10 (d, J=8.77 Hz, 2H), 4.09 (t, J=7.35 Hz, 1H), 3.28-3.19 (m, 2H), 2.92 (brs, 4H), 2.61-2.44 (m, 6H), 2.10-2.02 (m, 2H), 1.95-1.87 (m, 2H), 1.85-1.72 (m, 4H), 1.62-1.54 (m, 2H), 1.38-1.24 (m, 6H), 0.92-0.88 (m, 6H);

¹³C NMR (CDCl₃, 100 MHz): δ 194.36, 169.25, 161.35, 141.34, 130.98, 128.95, 128.74, 62.88, 47.61, 42.93, 31.97, 29.77, 29.74, 28.87, 28.23, 27.60, 26.47, 25.91, 25.27, 22.91, 22.73, 14.19.

15e, 97% Yield.

¹H NMR (CDCl₃, 400 MHz): δ 8.23 (d, J=8.33 Hz, 2H), 8.10 (d, J=8.36 Hz, 2H), 4.09 (t, J=7.37 Hz, 1H), 3.28-3.20 (m, 2H), 2.92 (brs, 4H), 2.60-2.45 (m, 6H), 2.11-2.01 (m, 2H), 1.94-1.90 (m, 2H), 1.86-1.73 (m, 4H), 1.65-1.56 (m, 2H), 1.38-1.22 (m, 10H), 0.90 (t, J=7.05 Hz, 6H);

¹³C NMR (CDCl₃, 100 MHz): δ 194.39, 169.30, 161.36, 141.36, 130.97, 128.95, 128.73, 62.87, 47.65, 43.14, 31.97, 31.92, 31.77, 29.98, 28.90, 28.24, 27.58, 27.28, 25.91, 25.26, 24.01, 22.69, 22.66, 14.25, 14.23.

15f, 92% Yield.

¹H NMR (CDCl₃, 400 MHz): δ 8.23 (d, J=8.17 Hz, 2H), 8.11 (d, J=8.26 Hz, 2H), 4.09 (t, J=7.26 Hz, 1H), 3.29-3.20 (m, 2H), 2.92 (brs, 4H), 2.61-2.42 (m, 6H), 2.11-2.02 (m, 2H), 1.95-1.90 (m, 2H), 1.86-1.77 (m, 4H), 1.64-1.58 (m, 2H), 1.37-1.22 (m, 14H), 0.89-0.84 (m, 6H);

¹³C NMR (CDCl₃, 100 MHz): δ 194.40, 169.22, 161.36, 141.37, 131.00, 128.96, 128.76, 62.88, 47.68, 43.21, 31.99, 31.85, 31.80, 30.06, 29.44, 29.30, 28.90, 28.26, 27.60, 25.91, 25.28, 24.29, 22.84, 22.79, 14.32, 14.29.

15g, 94% Yield.

¹H NMR (CDCl₃, 400 MHz): δ 8.22 (d, J=8.15 Hz, 2H), 8.10 (d, J=8.20 Hz, 2H), 4.09 (t, J=7.36 Hz, 1H), 3.27-3.20 (m, 2H), 2.92 (brs, 4H), 2.60-2.49 (m, 6H), 2.10-2.01 (m, 2H), 1.94-1.90 (m, 2H), 1.83-1.72 (m, 4H), 1.64-1.55 (m, 2H), 1.36-1.26 (m, 18H), 0.88-0.85 (m, 6H);

¹³C NMR (CDCl₃, 100 MHz): 6194.25, 169.36, 161.31, 141.30, 130.85, 128.92, 128.65, 120.91, 71, 21, 62.84, 43.12, 31.96, 31.90, 29.95, 29.67, 29.54, 29.27, 29.23, 28.86, 27.53, 25.91, 24.27, 22.79, 14.32.

15h, 91% Yield.

¹H NMR (CDCl₃, 400 MHz): δ 8.22 (d, J=8.33 Hz, 2H), 8.10 (d, J=8.40 Hz, 2H), 4.09 (t, J=7.33 Hz, 1H), 3.28-3.20 (m, 2H), 2.92 (brs, 4H), 2.62-2.46 (m, 6H), 2.11-2.01 (m, 2H), 1.94-1.90 (m, 2H), 1.85-1.74 (m, 4H), 1.62-1.58 (m, 2H), 1.36-1.25 (m, 22H), 0.88 (t, J=6.80 Hz, 6H);

¹³C NMR (CDCl₃, 100 MHz): δ 194.37, 169.24, 161.35, 141.36, 130.98, 128.95, 128.74, 62.87, 47.66, 42.20, 32.06, 32.04, 31.97, 30.05, 29.78, 29.63, 29.62, 29.58, 29.47, 29.44, 28.89, 28.25, 27.63, 27.60, 27.59, 25.91, 25.27, 24.33, 22.88, 22.87, 14.36, 14.34.

15i, 92% Yield.

¹H NMR (CDCl₃, 400 MHz): δ 8.23 (d, J=8.72 Hz, 2H), 8.10 (d, J=8.76 Hz, 2H), 4.09 (t, J=7.33 Hz, 1H), 3.28-3.20 (m, 2H), 2.92 (brs, 4H), 2.62-2.39 (m, 6H), 2.11-2.03 (m, 2H), 1.94-1.90 (m, 2H), 1.86-1.73 (m, 4H), 1.64-1.57 (m, 2H), 1.35-1.25 (m, 26H), 0.88 (t, J=6.73 Hz, 6H);

¹³C NMR (CDCl₃, 100 MHz): δ 194.37, 169.24, 161.36, 141.36, 130.99, 128.95, 128.74, 62.88, 47.66, 43.21, 32.10, 32.09, 31.98, 30.05, 29.78, 29.74, 29.73, 29.68, 29.64, 29.52, 29.50, 28.90, 28.25, 27.64, 27.60, 27.59, 25.91, 25.28, 24.30, 22.91, 22.89, 14.37, 14.35.

General Procedure for Syntheses of 16f, 16g and 16h

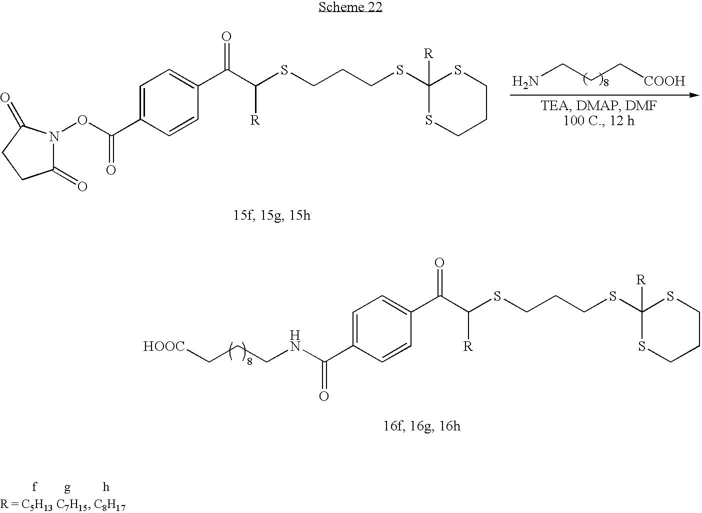

To a mixture 1-aminoundecanoic acid (0.35 mmol) and 15f (0.32 mmol) in DMF (10 mL) was added triethylamine (2 mL) and a catalytic amount of DMAP. The resulting solution was stirred at 100° C. for 12 h, poured onto crushed ice and acidified with 5% HCl solution. The solid obtained was filtered, washed with water and dried to give the desired compound 16f.

16f, 86% Yield.

¹H NMR (CDCl₃, 400 MHz): δ 8.04 (d, J=8.44 Hz, 2H), 7.84 (d, J=8.46 Hz, 2H), 6.21 (brt, J=5.59 Hz, 1H), 4.11 (t, J=7.34 Hz, 1H), 3.48 (q, J₁=7.06 Hz, J₂=13.20 Hz, 2H), 3.28-3.20 (m, 2H), 2.61-2.43 (m, 6H), 2.36 (t, J=7.44 Hz, 2H), 2.34-2.01 (m, 2H), 1.93-1.89 (m, 2H), 1.84-1.72 (m, 4H), 1.65-1.53 (m, 6H), 1.42-1.18 (m, 26H), 0.88-0.85 (m, 6H);

16g, 90% Yield.

¹H NMR (CDCl₃, 400 MHz): δ 8.02 (d, J=8.57 Hz, 2H), 7.84 (d, J=8.52 Hz, 2H), 6.40 (brt, J=5.65 Hz, 1H), 4.09 (t, J=7.31 Hz, 1H), 3.46 (q, J₁=6.79 Hz, J₂=13.35 Hz, 2H), 3.27-3.18 (m, 2H), 2.62-2.40 (m, 6H), 2.34 (t, J=7.46 Hz, 2H), 2.09-2.00 (m, 2H), 1.92-1.87 (m, 2H), 1.83-1.72 (m, 4H), 1.63-1.56 (m, 6H), 1.35-1.23 (m, 30H), 0.87-0.83 (m, 6H);

16h, 87% Yield.

¹H NMR (CDCl₃, 400 MHz): δ 8.05 (d, J=8.54 Hz, 2H), 7.84 (d, J=8.52 Hz, 2H), 6.21 (brt, J=5.57 Hz, 1H), 4.11 (t, J=7.32 Hz, 1H), 3.48 (q, J₁=6.97 Hz, J₂=13.28 Hz, 2H), 3.28-3.20 (m, 2H), 2.62-2.43 (m, 6H), 2.36 (t, J=7.46 Hz, 2H), 2.11-2.01 (m, 2H), 1.93-1.89 (m, 2H), 1.84-1.72 (m, 4H), 1.66-1.56 (m, 6H), 1.37-1.22 (m, 34H), 0.89-0.83 (m, 6H);

Procedure for Syntheses of 18b, 18d and 18e:

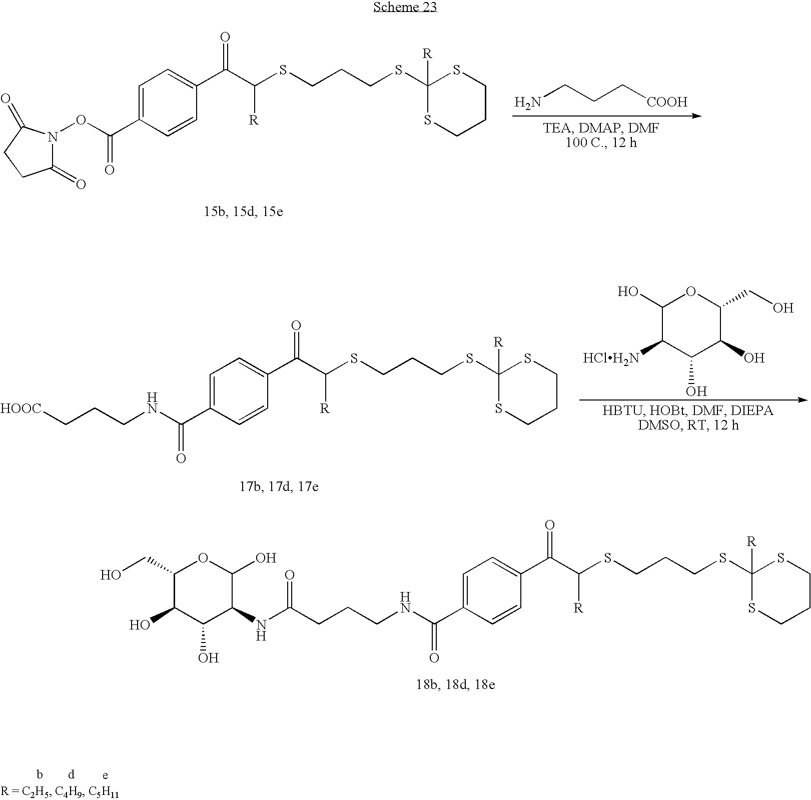

General Procedure for the Syntheses of 17b, 17d and 17e:

To a mixture of 4-aminobutyric acid (0.63 mmol) and 15b (0.57 mmol) in DMF (15 mL) was added triethylamine (2 mL) and a catalytic amount of DMAP. The resulting solution was stirred at 100° C. for 12 h, poured onto crushed ice and acidified with 5% HCl solution. The solid obtained was filtered, washed with water and dried to give pure 17b.

17b, 92% Yield.

¹H NMR (CDCl₃, 400 MHz): δ 8.03 (d, J=8.31 Hz, 2H), 7.87 (d, J=8.29 Hz, 2H), 6.85 (brt, J=5.55 Hz, 1H), 4.04 (t, J=7.34 Hz, 1H), 3.57 (q, J₁=6.35 Hz, J₂=12.40 Hz, 2H), 3.27-3.19 (m, 2H), 2.61-2.40 (m, 8H), 2.09-1.71 (m, 10H), 1.10 (t, J=7.38 Hz, 3H), 1.04 (t, J=7.32 Hz, 3H);

17d, 87% Yield.

¹H NMR (CDCl₃, 400 MHz): δ 8.04 (d, J=8.38 Hz, 2H), 7.87 (d, J=8.40 Hz, 2H), 6.75 (brt, J=5.54 Hz, 1H), 4.11 (t, J=7.40 Hz, 1H), 3.58 (q, J₁=6.10 Hz, J₂=12.42 Hz, 2H), 3.30-3.21 (m, 2H), 2.60-2.47 (m, 8H), 2.01-1.90 (m, 10H), 1.62-1.54 (m, 2H), 1.38-1.31 (m, 6H), 0.92 (t, J=7.28 Hz, 6H);

17e, 90% Yield.

¹H NMR (CDCl₃, 400 MHz): δ 8.04 (d, J=8.51 Hz, 2H), 7.87 (d, J=8.52 Hz, 2H), 6.72 (brt, J=5.55 Hz, 1H), 4.11 (t, J=7.32 Hz, 1H), 3.58 (q, J₁=6.05 Hz, J₂=12.38 Hz, 2H), 3.28-3.20 (m, 2H), 2.61-2.43 (m, 8H), 2.10-1.84 (m, 10H), 1.64-1.58 (m, 2H), 1.50-1.45 (m, 1H), 1.34-1.25 (m, 9H), 0.90 (t, J=7.07 Hz, 6H);

General Procedure for the Syntheses of 18b, 18d and 18e:

To a mixture of 17b (0.26 mmol), HBTU (0.29 mmol), and HOBt (0.29 mmol) in DM F (10 mL) was added DIPEA (0.58 mmol) and the reaction mixture was stirred for 5 min at ambient temperature. D-glucosamine hydrochloride (0.29 mmol) was dissolved in 1 mL of DMSO and added to the above reaction mixture and stirred at room temperature for 12 h. The solution was poured into cold ether and allowed to settle down. The ether layer was decanted off and the brownish yellow material was washed with cold ether several times and poured into crushed ice, the obtained solid was filtered and washed with water, hexane to get the pure 18b.

18b, 65% Yield.

¹H NMR (CD₃OD, 400 MHz): δ 8.11 (d, J=8.69 Hz, 2H), 7.94 (d, J=8.67 Hz, 2H), 5.11 (d, J=3.47 Hz, α-anomer), 4.61 (d, J=8.32 Hz, 0-anomer), 4.30 (t, J=7.32 Hz, 1H), 3.88-3.61 (m, 4H), 3.48-3.34 (m, 4H), 3.23-3.14 (m, 2H), 2.61-2.54 (m, 3H), 2.49-2.43 (m, 3H), 2.37-2.32 (m, 2H), 2.09-2.01 (m, 2H), 1.96-1.81 (m, 6H), 1.78-1.65 (m, 3H), 1.06 (m, 6H);

¹³C NMR (CD₃OD, 100 MHz): δ 195.79, 174.68, 167.95, 138.81, 138.34, 128.60, 127.47, 91.41, 71.94, 71.47, 71.30, 63.15, 61.64, 54.70, 48.79, 39.32, 35.73, 33.18, 31.33, 28.73, 28.01, 27.11, 27.10, 25.51, 25.08, 23.24, 11.02, 8.08.

18d, 64% Yield.

¹H NMR (CD₃OD, 400 MHz): δ 8.10 (d, J=8.44 Hz, 2H), 7.94 (d, J=8.30 Hz, 2H), 5.11 (d, J=3.58 Hz, α-anomer), 4.61 (d, J=8.34 Hz, β-anomer), 4.35 (t, J=7.32 Hz, 1H), 3.89-3.68 (m, 4H), 3.48-3.34 (m, 4H), 3.24-3.15 (m, 2H), 2.64-2.44 (m, 6H), 2.37-2.31 (m, 2H), 2.07-1.77 (m, 11H), 1.60-1.47 (m, 3H), 1.41-1.26 (m, 5H), 0.94-0.88 (m, 6H);

¹³C NMR (CD₃OD, 100 MHz): δ 195.70, 174.66, 167.94, 138.80, 138.36, 128.58, 127.47, 91.40, 71.93, 71.46, 71.31, 62.36, 61.63, 54.70, 46.99, 42.66, 39.30, 33.47, 33.16, 31.43, 29.88, 29.47, 28.70, 28.05, 27.15, 26.28, 25.50, 25.09, 22.58, 22.49, 13.20.

18e, 62% Yield.

¹H NMR (CD₃OD, 400 MHz): δ 8.10 (d, J=8.50 Hz, 2H), 7.98 (d, J=8.30 Hz, 2H), 5.25 (d, J=3.49 Hz, α-anomer), 4.77 (d, J=8.34 Hz, α-anomer), 4.36 (t, J=7.35 Hz, 1H), 3.92-3.71 (m, 4H), 3.46-3.34 (m, 4H), 3.25-3.15 (m, 2H), 2.68-2.44 (m, 7H), 2.10-1.98 (m, 2H), 1.92-1.81 (m, 7H), 1.63-1.52 (m, 4H), 1.39-1.24 (m, 11H), 0.91-0.88 (m, 6H);

¹³C NMR (CD₃OD, 100 MHz): δ 195.72, 174.67, 167.92, 138.80, 138.34, 128.58, 127.49, 91.40, 71.93, 71.45, 71.30, 62.42, 61.63, 54.65, 42.88, 42.63, 31.70, 31.45, 30.14, 28.73, 28.07, 27.16, 26.94, 25.10, 23.75, 22.45, 22.40, 17.56, 16.12, 13.23, 12.04.

Procedure for Syntheses of 19a, 19c and 19i

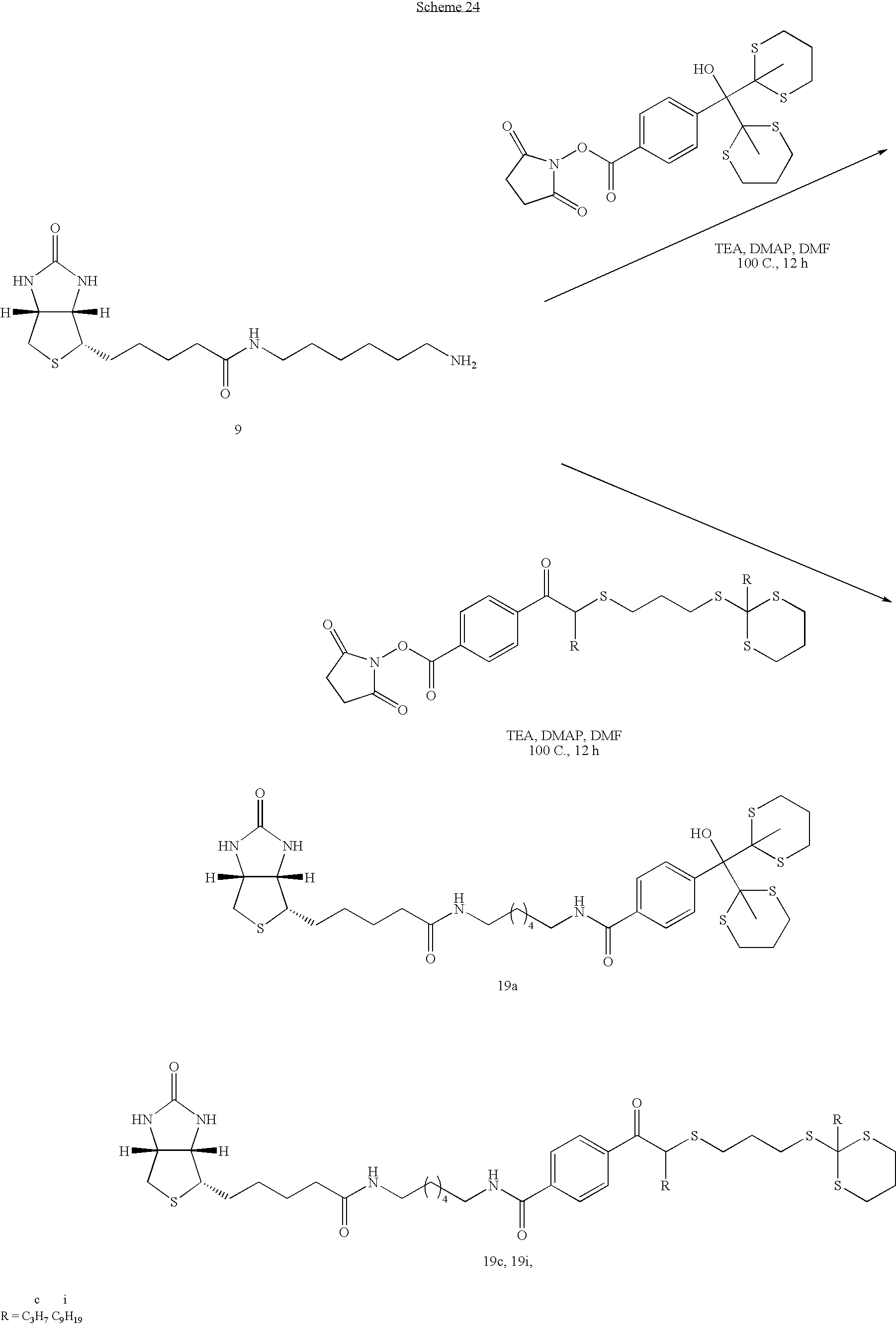

To a mixture of 9 (0.29 mmol) and 15a (0.22 mmol) in DMF (10 mL) was added triethylamine (1 mL) and a catalytic amount of DMAP. The resulting solution was stirred at 10° C. for 12 h, was poured onto crushed ice and the solid obtained was filtered, washed with water and dried to give pure 19a.

19a, 87% Yield.

¹H NMR (CD₃OD, 400 MHz): δ 8.50 (dd, J1=1.91 Hz, J2=8.48 Hz, 1H), 7.92 (d, J=2.01 Hz, 1H), 7.73 (dd, J₁=2.07 Hz, J₂=8.38 Hz, 1H), 7.66 (dd, J₁=2.07 Hz, J₂=8.49 Hz, 1H), 4.47-4.41 (m, 1H), 4.29-4.24 (m, 1H), 3.39 (t, J=7.07 Hz, 2H), 3.21-3.15 (m, 2H), 2.92-2.62 (m, 9H), 2.50-2.44 (m, 2H), 2.21 (t, J=7.37 Hz, 2H), 2.12 (s, 6H), 1.90-1.83 (m, 2H), 1.76-1.58 (m, 8H), 1.56-1.49 (m, 2H), 1.46-1.40 (m, 6H);

¹³C NMR (CD₃OD, 100 MHz): δ 178.72, 172.87, 148.51, 137.30, 134.82, 128.86, 127.84, 90.70, 66.70, 66.13, 64.36, 59.79, 43.81, 43.60, 42.97, 39.58, 33.22, 33.09, 32.56, 32.28, 31.94, 31.59, 31.55, 30.78, 30.74, 30.70, 30.45, 30.37, 29.72, 28.06.

19c, 90% Yield.

¹H NMR (DMSO-d₆, 400 MHz): δ 8.62 (brt, J=5.70 Hz, 1H), 8.08 (d, J=8.46 Hz, 2H), 7.93 (d, J=8.40 Hz, 2H), 7.74 (brt, J=5.52 Hz, 1H), 6.42 (brd, 2H), 4.54 (t, J=7.29 Hz, 1H), 4.29-4.26 (m, 1H), 4.11-4.08 (m, 1H), 3.26-3.20 (m, 2H), 3.09-2.96 (m, 6H), 2.81 (dd, J1=4.49 Hz, J2=12.39 Hz, 2H), 2.67-2.63 (m, 2H), 2.57-2.52 (m, 2H), 2.45-2.36 (m, 3H), 2.04-1.96 (t, J=7.40 Hz, 2H), 1.83-1.79 (m, 2H), 1.70-1.55 (m, 6H), 1.52-1.42 (m, 8H), 1.35-1.24 (m, 8H), 0.91-0.83 (m, 6H);

¹³C NMR (DMSO-d₆, 100 MHz): δ 172.46, 165.88, 163.37, 163.33, 138.35, 129.04, 128.10, 62.89, 61.71, 59.86, 59.74, 56.13, 46.39, 45.26, 38.97, 35.90, 35.86, 32.51, 31.76, 29.84, 29.71, 29.16, 28.90, 28.72, 28.43, 27.45, 27.43, 26.89, 26.85, 26.83, 26.04, 25.17, 20.61, 18.02, 14.54, 14.49.

19i, 92% Yield.

¹H NMR (DMSO-d₆, 400 MHz): δ 8.62 (brt, J=5.79 Hz, 1H), 8.06 (d, J=8.24 Hz, 2H), 7.93 (d, J=8.21 Hz, 2H), 7.74 (brt, J=5.37 Hz, 1H), 6.42 (brd, 2H), 4.52 (t, J=7.10 Hz, 1H), 4.29-4.26 (m, 1H), 4.11-4.08 (m, 1H), 3.26-3.21 (m, 2H), 3.07-2.98 (m, 6H), 2.81 (dd, J1=5.16 Hz, J2=12.37 Hz, 2H), 2.68-2.62 (m, 2H), 2.58-2.52 (m, 2H), 2.47-2.35 (m, 3H), 2.04-1.96 (m, 2H), 1.85-1.81 (m, 2H), 1.71-1.57 (m, 6H), 1.52-1.44 (m, 8H), 1.28-1.21 (m, 32H), 0.86-0.81 (m, 6H);

Procedure for the Synthesis of 20

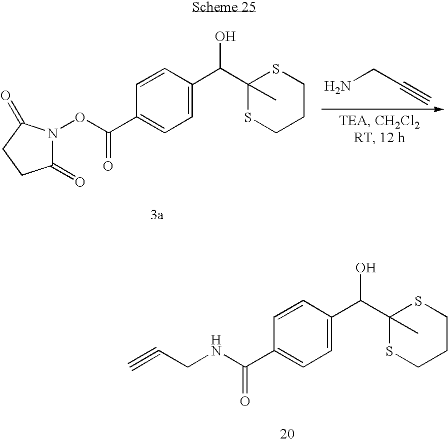

To a mixture mono-propargylamine (18 mg, 0.31 mmol) and 3a (100 mg, 0.26 mmol) in CH₂Cl₂ (10 mL) was added triethylamine (2 mL). The resulting solution was stirred at room temperature for 12 h, washed with 5% HCl, then water, and dried over anhyd.Na₂SO₄. The solvent was evaporated to obtain the pure compound.

20, 95% Yield.

¹H NMR (CDCl₃, 400 MHz): δ 7.73 (d, J=8.27 Hz, 2H), 7.56 (d, J=8.25 Hz, 2H), 6.33 (brt, 1H), 5.13 (s, 1H), 4.25-4.23 (m, 2H), 3.35 (s, 1H), 3.24-3.17 (m, 1H), 3.11-3.03 (m, 1H), 2.75-2.65 (m, 2H), 2.28 (t, J=2.49 Hz, 1H), 2.20-2.15 (m, 1H), 1.96-1.85 (m, 1H), 1.24 (s, 3H);

¹H NMR (CD₃OD, 400 MHz): δ 7.77 (d, J=8.14 Hz, 2H), 7.58 (d, J=8.14 Hz, 2H), 5.09 (s, 1H), 4.15 (d, J=2.07 Hz, 2H), 3.19-3.02 (m, 2H), 2.70-2.66 (m, 2H), 2.59 (s, 1H), 2.04-2.00 (m, 1H), 1.88-1.82 (m, 1H), 1.32 (s, 3H);

¹³C NMR (CD₃OD, 100 MHz): δ 168.44, 144.05, 133.10, 128.80, 126.01, 79.67, 76.48, 70.96, 52.84, 28.83, 26.58, 26.04, 24.61, 22.62.

Procedure for the Synthesis of 21 and 22.

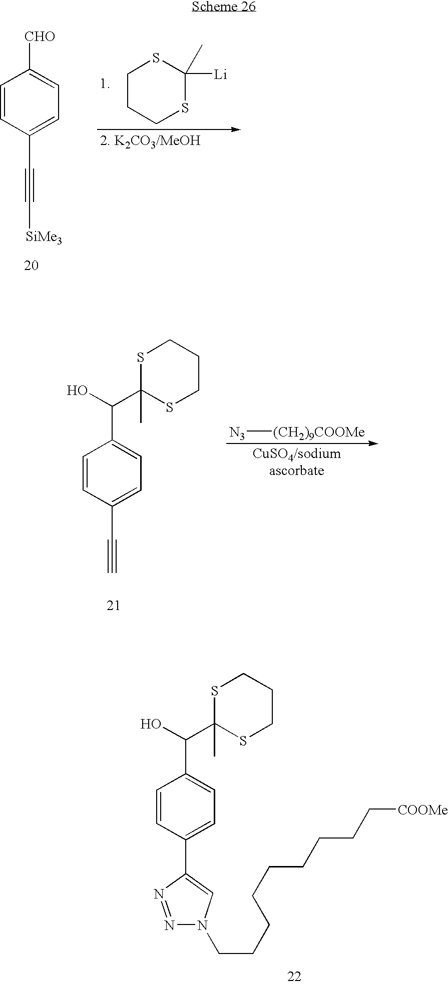

3.4 mL (14.3 mmol) of a 1.6M THF solution of butyllithium was added to a solution of methyl dithiane (0.66 g, 4.94 mmol) in dry THF (20 mL) dropwise during 3 min at RT, and the resulting solution was stirred at RT for 10 min. 4-((trimethylsilyl)ethynyl)benzaldehyde (0.5 g, 2.47 mmol) in 10 mL THF was added to the generated anion. The resulting solution was stirred at RT for 5 h. Saturated NH₄Cl (20 mL) was added to it and stirred for 10 min. The resulting solution was extracted with EtOAc (3×50 mL). The organic layer was dried over Na₂SO₄ and the solvent was evaporated. The residue was re-dissolved in 20 mL MeOH containing 0.34 g of K₂CO₃ and stirred overnight at ambient temperature. The solution was poured onto crushed ice and acidified with 5% HCl and extracted with ethyl acetate (50 mL). The organic layer was dried over Na₂SO₄ and the solvent was removed in vacuum. The product was purified by column chromatography with 5% EtOAc-hexane as eluent to give pure 21 (0.59 g, yield 90%).

¹H NMR (CDCl₃, 400 MHz): δ 7.44 (s, 4H), 5.07 (d, J=1.0 Hz, 1H), 3.31 (d, J=1.2 Hz, 1H), 3.17 (ddd, J=2.9 Hz, J=11.8 Hz, J=14.5 Hz, 1H), 3.08 (s, 1H), 3.04 (ddd, J=2.6 Hz, J=11.9 Hz, J=14.5 Hz, 1H), 2.74-2.62 (m, 2H), 2.18-2.10 (m, 1H), 1.95-1.83 (m, 1H), 1.25 (s, 3H)

Sodium ascorbate (43 mg, 0.22 mmol) was added to a mixture of acetylene 21 (0.29 g, 1.1 mmol) and methyl 10-azidodecanoate (0.27 g, 1.2 mmol) in 20 mL of ethanol, followed by addition of copper(II) sulfate pentahydrate (7.5% in water, 193 μL, 0.15 mmol). This heterogeneous mixture was stirred vigorously for 24 h at room temperature. The solvent was removed in vacuum, the residue was dissolved in dichloromethane and the organic layer was washed with water, dried over Na₂SO₄ and evaporated to give pure 22 (0.51 g, yield 95%).

¹H NMR (CDCl₃, 400 MHz): δ 7.78 (d, J=8.2 Hz, 2H), 7.73 (s, 1H), 7.53 (d, J=8.1 Hz, 2H), 5.12 (s, 1H), 4.38 (t, J=7.1 Hz, 3H), 3.65 (s, 3H), 3.30 (s, 1H), 3.22 (ddd, J=2.4 Hz, J=11.9 Hz, J=14.4 Hz, 1H), 3.08 (ddd, J=2.4 Hz, J=12.0 Hz, J=14.4 Hz, 1H), 2.71 (m, 2H) 2.28 (t, 1H, J=7.5 Hz), 2.17 (m, 1H) 1.93 (m, 2H+1H), 1.59 (m, 2H), 1.35-1.25 (m, 8H & s, 3H).

Procedure for the Modification of Avidin with ET-Sensitizer

To a solution of Avidin (10 mg, 0.147 μmol) in 1 mL 20 mM sodium phosphate buffer was added 100 μL of 13 (5 mg/mL in DMSO). The resulting mixture was gently shaken on a shaker for 2 h at ambient temperature. The excess reagent and reaction by-products were removed using a Sephadex G-25 column. The degree of immobilization was quantified spectroscopically, by fitting the UV absorption of the conjugate, Aconj, with a scaled sum of UV spectra of the original avidin, Aav, and 2-butylaminocarbonylxanthone, Ax, in the range from 240 to 390 nm: A_{conj}=kₐᵥAₐᵥ/[av]+kₓAₓ/[x], where [av] and [x] are the respective molar concentrations of avidin and the xanthone carboxamide. The ratio of scaling factors kₓ/kₐᵥ was determined to be 0.77 (rms fit is 0.003 over 150 data points) indicating that each tetramer of avidin was carrying approximately three tethered xanthone-2-carboxylate moieties on average.

Formation of Micelle and Photochemistry

0.5 mg each of 10a, 6b, 6c, 6d, 4e, 10f, 4g, 4h and 10i were added to a solution of DPC (60 mg) in 0.6 mL of D₂O. The mixture was stirred for 24 h at ambient temperature until a clear micellar solution was obtained. To this solution 0.5 mL of avidin-xanthone conjugate was added. The resulting solution was incubated in an orbital shaker for 1 h, degassed with argon for 45 min and then irradiated for 4 h using Rayonet reactor (RPR-3500 lamps) and a 330 nm long pass solution filter. The micellar solution was extracted with 0.5 mL hexane and concentrated to 0.1 mL to be analyzed by GCMS.

Although the description herein contains many specificities, these should not be construed as limiting the scope of the invention, but as merely providing illustrations of some of the preferred embodiments of the invention. For example, library members, releasable tags, target compounds and sensitizers other than those specifically exemplified herein may be used, as known to one of ordinary skill in the art without undue experimentation. In addition, chemical synthesis methods to attach all groups described herein, including releasable tags to library members and sensitizers to target compounds are known to one of ordinary skill in the art. Useful linkages between groups are also within the skill of one of ordinary skill in the art. Additional embodiments are within the scope of the invention described in the specification and within the following claims.

When a group of substituents is disclosed herein, it is understood that all individual members of those groups and all subgroups, including any isomers and enantiomers of the group members, and classes of molecules that can be formed using the substituents are disclosed separately. When a molecule is claimed, it should be understood that molecules known in the art including the molecules disclosed in the references disclosed herein are not intended to be included. In particular, it should be understood that any molecule for which an enabling disclosure is provided in any reference cited in this specification is to be excluded from the claims herein if appropriate. When a Markush group or other grouping is used herein, all individual members of the group and all combinations and subcombinations possible of the group are intended to be individually included in the disclosure. Unless otherwise indicated, when a molecule is described and/or claimed herein, it is intended that any ionic forms of that molecule, particularly carboxylate anions and protonated forms of the molecule as well as any salts thereof are included in the disclosure. Counter anions for salts include among others halides, carboxylates, carboxylate derivatives, halogenated carboxylates, sulfates and phosphates. Counter cations include among others alkali metal cations, alkaline earth cations, and ammonium cations.

Every formulation or combination of components described or exemplified can be used to practice the invention, unless otherwise stated. Specific names of molecules are intended to be exemplary, as it is known that one of ordinary skill in the art can name the same molecules differently. When a molecule is described herein such that a particular isomer or enantiomer of the molecule is not specified, for example, in a formula or in a chemical name, that description is intended to include each isomer and enantiomer of the molecule described individually or in any combination. One of ordinary skill in the art will appreciate that methods, device elements, starting materials, synthetic methods, and detection methods other than those specifically exemplified can be employed in the practice of the invention without resort to undue experimentation. All art-known functional equivalents, of any such methods, starting materials, synthetic methods, and detection methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

In general the terms and phrases used herein have their art-recognized meaning, which can be found by reference to standard texts, journal references and contexts known to those skilled in the art. The specific definitions are provided to clarify their specific use in the context of the invention.

All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The molecules and methods and accessory methods described herein as presently representative of preferred embodiments are exemplary and are not intended as limitations on the scope of the invention. Changes therein and other uses will occur to those skilled in the art, which are encompassed within the spirit and scope of the invention.

All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention. The disclosure of provisional applications 60/697,732 and 60/697,760, filed Jul. 8, 2005, and PCT/US06/025812 and PCT/US061025815, filed Jun. 30, 2006, are incorporated herein by reference.

### REFERENCES

Schoevaars, A. M.; Kruizing a, W.; Zijlstra, R. W. J.; Veldman, N.; Spek, A. L.; Fering a, B. L. J. Org. Chem. 1997, 62, 4943.
Kurchan, A. N.; Kutateladze, A. G. Org. Lett., 2002, 4, 4129.
McHale, W. A.; Kutateladze A. G. An Efficient Photo-SET-Induced Cleavage of Dithiane-Carbonyl Adducts and Its Relevance to the Development of Photoremovable Protecting Groups for Ketones and Aldehydes. J. Org. Chem., 1998, 63, (26), 9924-9931. [DOI: 10.1021/jo981697y]
Vath, P.; Falvey, D. E.; Barnhurst, L. A.; Kutateladze, A. G. Photoinduced C—C Bond Cleavage in Dithiane-Carbonyl Adducts: A Laser Flash Photolysis Study. J. Org. Chem., 2001, 66, (8), 2886-2890. [DOI: 10.1021/jo010102n]
Mitkin, O. D.; Kurchan, A. N.; Wan, Y.; Schiwal, B. F.; Kutateladze, A. G. Dithiane and Trithiane-Based Photolabile Scaffolds for Molecular Recognition. Org. Lett., 2001, 3, (12), 1841-1844. [DOI: 10.1021/ol105933u]
Ci, X.; Whitten, D. G. Photochemical dehydrofragmentation reactions: importance of donor and acceptor structure in determination of reactivity in radical ion pairs formed in electron transfer photoreactions. J. Am. Chem. Soc. 1987, 109, 7215-7217.
Ci, X.; Whitten, D. G. Photofragmentation via single-electron transfer: selective labilization of carbon-carbon bonds in amino alcohols with several bonds between heteroatom substituents. J. Am. Chem. Soc. 1989, 111, 3459-3461.
Wan, Y.; Kurchan, A. N.; Barnhurst L. A.; Kutateladze, A. G. Direct Transformation of 1,3-Dihalides into Dithianes and Dithiepins via a Novel One Pot Reaction with Carbon Disulfide and Sodium Borohydride. Org. Lett., 2000, 2, (8), 1133-1135. [DOI: 10.1021% ol005705k]
Gyenes, F.; Bergmann, K. E.; Welch, J. T. Convenient Access to Primary Amines by Employing the Barbier-Type Reaction of N-(Trimethylsilyl)imines Derived from Aromatic and Aliphatic Aldehydes. J. Org. Chem. 1998, 63, 2824.
Barnhurst, L. A.; Wan, Y.; Kutateladze A. G. Efficient Electrochemical Deprotection of Carboxylic and Amino Acids from Their 2-(Hydroxymethyl)-1,3-dithiane (Dim) Esters. Org. Lett., 2000, 2, (6), 799-801. [DOI: 10.1021/ol005537w]
Wan Y., Barnhurst, L. A.; Kutateladze A. G. Photooxidation of Methyldithiepins into Dithiepin Carboxaldehydes in Carbon Tetrachloride. Org. Lett. 1999, 1 (6), 937-939. [DOI: 10.1021/ol990870p]
Wan, Y.; Kurchan, A. N.; Kutateladze, A. G. Photoinduced 1,3-Proton Shift in Methyldithiepines as a Potential Way of Modulating Hyperpolarizabilities. J. Org. Chem., 2001, 66, (5), 1894-1899. [DOI: 10.1021/io005707i]
Mitkin, O.; Wan, Y.; Kurchan, A.; Kutateladze, A. Synthesis of Dithiane-Based Photolabile Molecular Systems. Synthesis, 2001, (8), 1133-1142.
Wan, Y.; Mitkin, O.; Barnhurst L.; Kurchan, A.; Kutateladze, A. Molecular Assembly and Disassembly: Novel Photolabile Molecular Hosts. Org. Lett., 2000, 2, (24), 3817-3819. [DOI: 10.1021/ol006692d]
Barnhurst, L. A.; Kutateladze, A. G. Synthesis and Liquid Membrane Transport Properties of Photolabile Molecular Clips Based on Dithiane-Spiro-Crown Ethers. Org. Lett., 2001, 3, (17), 2633-2635. [DOI: 10.1021%1106309k]
Wan, Y.; Angleson, J. K.; Kutateladze, A. G. Liposomes from Novel Photolabile Phospholipids: Light-Induced Unloading of Small Molecules as Monitored by PFG NMR. J. Am. Chem. Soc., 2002, 124, (20), 5610-5611. [DOI: 10.1021/ja016874i]
Kurchan, A. N.; Kutateladze, A. G. Amino Acid-Based Dithiazines: Synthesis and Photofragmentation of Their Benzaldehyde Adducts. Org. Lett., 2002, 4, (23), 4129-4131. [DOI: 10.1021% ol268790]
Juaristi, E.; Gonzalez, E. A.; Pinto, B. M.; Johnson, B. D.; Nagelkerke, R. The existence of Second-Row Anomeric Interactions. Conformational Analysis of 2 Substituted 5-methyl-5-aza-1,3-dithiacyclohexanes. J. Am. Chem. Soc. 1989, 111, 6745-6749.
Larock, R. C.; Comprehensive organic transformations. VCH Publishers Inc., 1989, p. 409-410.
Portnyagina, V. A.; Fedoseeva, V. N.; Kolyadich, E. P. Synthesis and properties of 1,3-dimercapto derivatives of aromatic carboxylic acids and o-aminophenol. Ukr. Khim. Zh. 1981, 47(8), 857-61;
Portnyagina, V. A.; Fedoseeva, V. N.; Kolyadich, E. P. β-Dithiols as derivatives of aliphatic carboxylic acids. Ukr. Khim. Zh. 1981, 47(9), 962-4.
Borgulya, J.; Daly, J. J.; Schönholzer, P.; Bernauer, K. Rearrangement of Derivatives of 1,3-Dithiane-5-amine into Bicyclic 2-Thiazolidines. Crystal Structures of cis- and trans-1-(2-Aryl-1,3-dithian-5-yl)-2-thioureas and cis- and trans-5-Aryl-3-imino-7,7a-dihydro-1H,3H,5H-thiazolo[3,4-c]thiazoles. Helv. Chim. Acta, 1984, 67, 1827-1842.
Salvatore, R. N.; Nagle, A. S.; Jung K. W. Cesium Effect: High Chemoselectivity in Direct N-Alkylation of Amines. J. Org. Chem. 2002, 67, 674-683
Conn, M. M.; Rebek, J., Jr. Self-Assembling Capsules. Chem. Rev. 1997, 97(5), 1647-1668.
Rebek, J., Jr. Reversible Encapsulation and Its Consequences in Solution. Acc. Chem. Res. 1999, 32(4), 278-286.
Chang, S. K.; Hamilton, A. D. Molecular recognition of biologically interesting substrates: synthesis of an artificial receptor for barbiturates employing six hydrogen bonds. J. Am. Chem. Soc. 1988, 110, 1318-19.
Kita, K.; Kida, T.; Nakatsuji, Y.; Ikeda, I. Molecular Design of C-Pivot Tripodal Ligands: Importance of the Glycerol Structure for Effective Complexation toward Alkali Metal Cations. J. Org. Chem. 1997, 62(23), 8076-8081.
Dale, J.; Fredriksen, S. B. Reactivity of neopentyl-like compounds in the synthesis of branched polyethers. Acta Chem. Scand., 1992, 46(3), 278-82.
Esnault, J.; Mallet, J.-M.; Zhang, Y.; Sinay, P.; Le Bouar, T.; Pincet, F.; Perez, E. New highly hydrophobic Lewis X glycolipids: synthesis and monolayer behavior. Eur. J. Org. Chem. 2001, 2, 253-260.
Seidel, S. R.; Stang, P. J. High-Symmetry Coordination Cages via Self-Assembly. Acc. Chem. Res. 2002, 35(11), 972-983.
Fukunaga, M.; Sugawara, T.; Oki, M. Alkylation of 1,3,5-trithianes. Chem. Lett. 1972, (1), 55-58.
Rutledge, A.; Abell, C.; Balasubramanian, S. The use of a dithiane-protected benzoin photolabile safety catch linker for solid-phase synthesis. Tetrahedron Lett. 1997, 38(7), 1227-1230.
Lee H. B.; Balasubramanian, S. Studies on a Dithiane-Protected Benzoin Photolabile Safety Catch Linker for Solid-Phase Synthesis. J. Org. Chem. 1999, 64, 3454-3460.
Methods in Enzymology. Wilchek, M.; Bayer, E. A. Editors; Academic Press, 1990,
Wagner, P. J.; Kemppainen, A. E.; Schott, H. N. Effects of ring substituents on the type II photoreactions of phenyl ketones. How interactions between nearby excited triplets affect chemical reactivity. J. Am. Chem. Soc., 1973, 95(17), 5604-5614
Sarkar, S. K.; Garigipati, R. S.; Adams, J. L.; Keifer, P. A. An NMR Method To Identify Nondestructively Chemical Compounds Bound to a Single Solid-Phase-Synthesis Bead for Combinatorial Chemistry Applications. J. Am. Chem. Soc. 1996, 118, 2305-2306.
Brenner, S.; Lerner, R. A. Encoded Combinatorial Chemistry. Proc. Natl. Acad. Sci. USA, 1992, 89, 5381-5383.
Ohlmeyer, M. H. J.; Swanson, R. N.; Dillard, L. W.; Reader, J. C.; Asouline, G.; Kobayashi, R.; Wigler, M.; Still, W. C. Proc. Natl. Acad. Sci. USA, 1993, 90, 10922-10926.
Nestler, H. P.; Bartlett, P. A. Still, W. C. A General Method for Molecular Tagging of Encoded Combinatorial Chemistry Libraries. J. Org. Chem. 1994, 59, 4723-4724.
Kottani, et al. Direct screening of solution phase combinatorial libraries encoded with externally sensitized photolabile tags. PNAS. 2006, 103, 13917-13912.
Gustafson, Kurchan, Kutateladze. Tetrahedron 2006, 62, 6574-6580.
Brown, Biochim Biophys Acta, 1981, 642, 296-312.
Valiulin, Kottani, Kutateladze, J. Org. Chem., 2006, 71, 5047-5049.
Franz, J. Comb. Chem., 2003, 2003, 5, 125-137.
Liu, J. Am. Chem. Soc., 2002, 124, 7678-7680.
Saxon, Science, 2000, 287, 2007-2010.
Saxon, Org. Lett., 2000, 2, 2141-2143.
Nilsson, Org. Lett. 2000, 2, 1939-1941.
Kolb, Angew Chem Int Ed., 2001, 40, 2004-2021.

We claim:

1. A method of screening a library comprising:
(A) providing either
(i) a library comprising more than one copy of different library members, each copy of a different library member attached to a different releasable tag through a releasable covalent bond; where a plurality of tags uniquely encode each library member; or (ii) a library comprising one or more copies of a library member attached to a support, with a plurality of tags uniquely encoding each library member; or (iii) a library comprising different library members, each different library member attached to a plurality of tags uniquely encoding the different library member;
(B) providing a target compound with tethered sensitizer in specific binding proximity to the library, allowing specific binding of the target compound with tethered sensitizer to a selected library member;
(C) exciting the tethered sensitizer with excitation photoradiation, whereby the releasable tags attached to the selected library member are released; and
(D) detecting the releasable tags.

2. A method for detecting the signal from a binding assay comprising:
(A) providing a reaction mixture comprising in combination:
(i) a medium comprising a target compound with tethered sensitizer; and
(ii) a medium comprising either (a) a library comprising more than one copy of different library members, each copy of a different library member attached to a different releasable tag through a releasable covalent bond; or (b) a library comprising one or more copies of a library member attached to a support, with a plurality of tags uniquely encoding each library member; or (c) a library comprising different library members, each different library member attached to a plurality of tags uniquely encoding the different library member;
(B) equilibrating the reaction mixture to allow association of the target compound with tethered sensitizer and the library members, wherein the target compound with tethered sensitizer associates with a selected library member;
(C) exciting the tethered sensitizer, said excitation causing the release of the different releasable tags from the selected library member; and
(D) detecting the releasable tags.

3. The method of claim 1 or 2, wherein the releasable tags are selected from the group consisting of: carbonyl-containing dithiane groups and ester-containing bis-dithiane groups.

4. The method of claim 1 or 2, wherein the target compound with tethered sensitizer is a biomolecule.

5. The method of claim 4, wherein the target compound with tethered sensitizer is a protein.

6. The method of claim 1 or 2, wherein the target compound with tethered sensitizer contains a member of the group consisting of: carbonyl-, cyano-, nitro-, amino-, and sulfido-groups.

7. The method of claim 6, wherein the target compound with tethered sensitizer contains a member of the group consisting of: benzophenones, xanthones, dicyanonaphthalene, and dicyanoanthracene.

8. The method of claim 1 or 2, further comprising a support.

9. The method of claim 1 or 2, wherein the library does not contain a support.

10. The method of claim 1 or 2, wherein the target compound and selected library member are members of a ligand-receptor pair.

11. The method of claim 1 or 2, wherein the detecting step is performed using GC-MS.

12. A library comprising: more than one copy of different library members, each copy of a different library member attached to a different releasable tag through a releasable covalent bond a plurality of library members.

13. The library of claim 12, wherein the releasable tags are selected from the group consisting of: carbonyl-containing dithiane groups and ester-containing bis-dithiane groups.

14. A library comprising library members, wherein one or more copies of a library member is attached to a support, with a plurality of tags uniquely encoding each library member.

15. A library comprising: one or more library members, each different library member attached to a plurality of tags uniquely encoding the different library member.

16. A kit for conducting an assay for an analyte, which kit comprises, in packaged combination, a composition comprising: more than one copy of different library members, each copy of a different library member attached to a plurality of different releasable tags through releasable covalent bonds, where a plurality of tags uniquely encode each library member.

17. The kit of claim 16, wherein the plurality of library members is provided in solution or suspension.

18. The kit of claim 16, wherein the plurality of library members is attached to a support.

19. A kit for conducting an assay for an analyte, which kit comprises, in packaged combination; a composition comprising:
one or more copies of a library member attached to a support with a plurality of tags uniquely encoding each library member.

20. A kit for conducting an assay for an analyte, which kit comprises, in packaged combination; a composition comprising:
one or more different library members, each different library member attached to a plurality of tags uniquely encoding the different library member.

21. A method of screening a library comprising:
(A) providing a library comprising one or more copies of a library member attached to a support, with a plurality of tags uniquely encoding each library member;
(B) cleaving the support from the library members;
(C) providing a target compound with tethered sensitizer in specific binding proximity to the library, allowing specific binding of the target compound with tethered sensitizer to a selected library member;
(D) exciting the tethered sensitizer with excitation photoradiation, whereby the releasable tags attached to the selected library member are released; and
(E) detecting the releasable tags.

22. The method of claim 21, wherein the tags are attached to the library member through an azide group.

23. The method of claim 22, wherein the tags are attached to the library member using click chemistry or a Staudinger ligation.

24. The method of claim 21, wherein the releasable tags comprise: 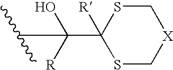
where R′ is selected from the group consisting of: dithiane group, H, OH, and alkyl having from 1 to 30 carbon atoms;
R is selected from the group consisting of: H, straight chain and branched alkyl having from 1 to 30 carbon atoms, —Cₙ—Y—Cₘ— wherein Y is S or O, and n and m are independently integers from 0 to 30, and OH;
and X is CH, CH₂, or heteroatom.
